(19) United States
(12) Patent Application Publication
(10) Pub. No.: US 2007/0221731 A1
(43) Pub. Date: Sep. 27, 2007

(54) Using markers to identify objects for visually-impaired people

(75) Inventor: Christopher P. Ricci, Dayton, OH (US)

Correspondence Address: Intellectual Property Section;Law Department, NCR Corporation, 1700 South Patterson Blvd., Dayton, OH, 45479-0001, US

(73) Assignee: Prime Technology LLC

(21) Appl. No.: 11/388,334

(22) Filed: Mar. 24, 2006

(51) Int. Cl. G06K 7/10

(52) U.S. Cl. 235/462.01

(57) ABSTRACT

According to various illustrative embodiments of the present invention, a reader capable of identifying at least one product by providing non-visual sensory information to a user, the reader comprising: a source which stimulates a response from a marker carried by the at least one product; a detector which detects the response from the marker; a decoder which decodes the detected response to ascertain product identification information therefrom; and a transducer which provides the product identification information in non-visual form. The information may be provided in audible form, such as a tone or as speech.

### FIELD OF THE INVENTION

This invention relates generally to markers that are attached to and/or embedded in objects and methods for using the same and, more particularly, to a marker that contains indicia that may identify the origin of the marker, and, thus, the origin and/or nature of the object so marked, and to a method for marking objects such as products.

### BACKGROUND OF THE INVENTION

Markers, such as security markers, may be used to identify and/or to authenticate items. For example, bank notes typically include security markers such as watermarks, luminescent inks, security threads, holograms, kinegrams, and the like. However, with advances in copying technology, it is becoming more difficult to provide security markers that are not only difficult to counterfeit, but also easy to detect, quick to detect in situ, and inexpensive to manufacture.

Chemical and/or biochemical taggants may also be used, as security markers, for example. However, in many cases such taggants must be removed from the item prior to being analyzed. This is both time-consuming and expensive.

Optically-based approaches, such as luminescent labels, have also been used. Luminescent materials emit light when excited by radiation of a particular wavelength. Information may be encoded in luminescent inks, and may only be retrieved when the mark is illuminated with radiation of the appropriate wavelength.

An example of a particular type of luminescent ink is described in U.S. Pat. No. 5,256,193, which is hereby incorporated by reference. The following patents describe various security labeling and printing applications, and are hereby incorporated by reference: JP 8208976; U.S. Pat. No. 4,736,425; U.S. Pat. No. 5,837,042; U.S. Pat. No. 3,473,027; U.S. Pat. No. 5,599,578; GB 2,258,659; U.S. Pat. No. 6,344,261; and U.S. Pat. No. 4,047,033.

However, known inks and dyes have the disadvantage that they have very broad spectra, which limits the number of inks and dyes that may be used in a particular item. An example may illustrate this limitation. Consider the visible spectrum, which ranges from red, through orange, yellow, green, blue, indigo, and violet. One ink may produce a color that spans from red through green. Another ink may produce a color that spans from green through violet. Thus, if these two inks are used, it may be difficult to use a third ink with these two inks, because the first two inks cover the entire visible spectrum. For many purposes, it is desirable to use inks having a narrower spectrum, such as an ink that occupies only the red part of the spectrum, or less. In general, luminescent inks do not offer this property.

With respect to markers and/or marking that may be useful for the visually impaired, the various difficulties that the visually impaired endure are well chronicled. One such difficulty is distinguishing like items. One example is currency. When currencies are not distinguished by size, such as the currency of the United States, then the visually impaired may accidentally pay more than is required for products, or otherwise tender incorrect amounts or receive incorrect amounts in change. A common method of handling this issue is to fold different denominations uniquely and to detect the denomination by the fold. However, this is time consuming and provides no way for the visually impaired person to determine if currency being tendered to them is correct.

Another example is cans or jars of food. Some cans have distinctive ring patterns to allow the visually impaired to ascertain the type of food contained therein. However, these are few, in general. Often, the visually impaired person must purchase larger or smaller sizes of items, just so they may be distinguished on their shelves at home.

### SUMMARY OF THE INVENTION

A need exists for products to have a marker on the product for at least the visually impaired. The marker may be useful for other purposes as described below. The marker should be inexpensive enough to be included in the packaging and easy enough to apply so that the marker and/or the marking may become substantially ubiquitous.

In one aspect, according to various illustrative embodiments, a reader is provided that is capable of identifying at least one product by providing non-visual sensory information to a user, the reader comprising: a source which stimulates a response from a marker carried by the at least one product; a detector which detects the response from the marker; a decoder which decodes the detected response to ascertain product identification information therefrom; and a transducer which provides the product identification information in non-visual form.

The source may be an excitation source, and the marker may comprise at least one luminophore. The excitation source may be in the ultra-violet or visible range of wavelengths (approximately 300 nm to 790 nm). The detector may measure luminescence intensity at one or more wavelengths.

The transducer may produce at least one audible tone, or an audible description to identify the product. Alternatively or additionally, the transducer may produce a tactile response that can be decoded by a user.

The source may be a radio-frequency source, and the marker may be a radio-frequency identification device. The detector may be a radio-frequency detector.

In another aspect, according to various illustrative embodiments, a method for marking at least one product comprises disposing a plurality of luminophores within an ink, each of the luminophores being capable of emitting electromagnetic radiation having at least one known characteristic frequency in response to electromagnetic radiation having at least one predetermined excitation frequency, the plurality of the luminophores being selected to encode information for marking the at least one product. The method also comprises using the ink to mark at least one of the at least one product and at least one package for the at least one product. The luminophore may comprise a host incorporating a rare earth ion. The host may incorporate the rare earth ion at a spacing that permits interactions between the rare earth ion and the host, thereby providing a unique characteristic frequency. The host may be an organic host (such as a polymer) or an inorganic host (such as a glass). The luminophores may have any convenient shape, such as that of a bead, a rod, a flake, or such like.

In another aspect, according to various illustrative embodiments, a system for indicating marking information for at least one product comprises an ink having a plurality of luminophores disposed within, each of the luminophores being capable of emitting electromagnetic radiation having at least one known characteristic frequency in response to electromagnetic radiation having at least one predetermined excitation frequency, the plurality of the luminophores being selected to encode information for marking the at least one product using the ink to mark at least one of the at least one product and at least one package for the at least one product. The system also comprises a reader capable of decoding the information for marking the at least one product.

In yet another aspect, according to various illustrative embodiments, a system for indicating marking information for at least one product comprises an ink having a plurality of luminophores disposed within, each of the luminophores being capable of emitting electromagnetic radiation having at least one known characteristic frequency in response to electromagnetic radiation having at least one predetermined excitation frequency, the plurality of the luminophores being selected to encode information for marking the at least one product using the ink to mark at least one of the at least one product and at least one package for the at least one product. The system may also comprise a reader capable of decoding the information for marking the at least one product, wherein at least some of the plurality of the luminophores have at least one dopant disposed within rendering the at least some of the plurality of the luminophores being capable of responding to at least one of at least one luminescence-exciting frequency and at least one narrow-band radio-frequency (RF) excitation.

In still yet another aspect, according to various illustrative embodiments, an ink useful for indicating marking information for at least one product comprises a plurality of luminophores disposed within the ink, each of the luminophores being capable of emitting electromagnetic radiation having at least one known characteristic frequency in response to electromagnetic radiation having at least one predetermined excitation frequency, the plurality of the luminophores being selected to encode information for marking the at least one product using the ink to mark at least one of the at least one product and at least one package for the at least one product, wherein at least some of the plurality of the luminophores have at least one dopant disposed within rendering the at least some of the plurality of the luminophores capable of responding to at least one of at least one luminescence-exciting frequency and at least one narrow-band radio-frequency (RF) excitation.

In yet still another aspect, according to various illustrative embodiments, a reader capable of decoding information for marking at least one product and indicating the information for marking comprises a device capable of exposing an ink to at least one predetermined excitation frequency of radiation, detecting at least one known characteristic frequency by absorbing the at least one known characteristic frequency and, depending on the at least one known characteristic frequency, thereafter decoding the information for marking the at least one product, and then indicating the information for marking the at least one product to the at least one person using at least one of an audible tone, a series of audible tones, and a tactile response indicator, wherein the ink comprises a plurality of luminophores disposed within, each of the luminophores being capable of emitting electromagnetic radiation having the at least one known characteristic frequency in response to electromagnetic radiation having the at least one predetermined excitation frequency, the plurality of the luminophores selected to encode the information for marking the at least one product using the ink to mark at least one of the at least one product and at least one package for the at least one product, wherein at least some of the plurality of the luminophores have at least one dopant disposed within rendering the at least some of the plurality of the luminophores capable of responding to at least one of at least one luminescence-exciting frequency and at least one narrow-band radio-frequency (RF) excitation.

In various illustrative embodiments, an organic or inorganic composition may be fabricated that produces a unique optical signature and/or other electromagnetic signature in response to exciting radiation, and the composition may be difficult to copy to form a second composition that produces the same unique optical signature. This composition may be broken down into smaller particles that may be used as markers, such as security markers, for example.

According to various aspects, an electromagnetically detectable marker, such as an optically detectable marker, such as a security marker, for example, for emitting electromagnetic radiation, such as light, at a pre-selected wavelength, may be provided, the marker comprising a rare earth dopant and a host incorporating the rare earth dopant, the interaction of the host and the dopant being such as to provide a luminescent fingerprint and/or another electromagnetic response that may be different from that of the rare earth dopant.

The rare earth element that may be used as the dopant may have an intrinsic set of electronic energy levels. The interaction between the host and the dopant may be such that these intrinsic energy levels change when the dopant is incorporated into the host. For example, when the dopant is incorporated into a glass, new energy levels (from the glass) may be made available for radiative transitions, thus, altering the electron arrangement and, hence, the energy levels of absorption and luminescent emission and/or resonant electromagnetic emission. These transitions may assist recombinations that may have been previously prohibited, for example. Altering the rare earth dopant and/or dopant chelate and/or the composition of the carrier may change these energy levels and, hence, the observed luminescent fingerprint and/or other electromagnetic emission.

By virtue of these aspects, an electromagnetically detectable marker, such as an optically detectable marker, such as a security marker, for example, may be provided that may be tailored to have strong luminescent light emission at a pre-selected wavelength when illuminated with a particular wavelength of light. This may enable a validator to validate the marker, such as a security marker, for example, by detecting emission at the pre-selected wavelength in response to radiation at a particular wavelength. Such a marker, such as a security marker, for example, may be very difficult to replicate by a counterfeiter.

The rare earth dopant may be a lanthanide. The host may comprise an organic or inorganic material (such as a plastic or a glass). The host in which the rare earth dopant may be embedded may readily be produced in a variety of formats, for example, microbeads and/or fibers suitable for inclusion in products (such as those made from plastic or paper). Alternatively the rare earth dopant may be an integral part of the polymer matrix forming a product.

Due to the discrete luminescence wavelength and/or resonant electromagnetic emission wavelength of a host doped with a rare earth element, multiple hosts may be used (or a single host doped with multiple rare earth elements), each prepared to have a different pre-selected emission wavelength, so that an identification profile, such as a security profile, for example, comprising multiple wavelengths may be provided in a single item without the different wavelengths overlapping each other. This may enable a marker, such as a security marker, for example, to be provided that has an identification profile, such as a security profile, selected from a large number of permutations, thereby greatly increasing the difficulty in counterfeiting such a marker, such as a security marker, for example.

The host doped with the rare earth ion may have a new energy level profile that may allow transitions different from those allowed by either the rare earth element or the undoped host. The new energy profile may be particularly advantageous for security purposes because the new energy profile may provide narrow emissions at wavelengths not naturally found in either the rare earth element or the undoped host. These narrow emissions may be used as part of a marker, such as a security marker, for example.

A plurality of rare earth dopants may be used. One or more of these different rare earth dopants may have intrinsic luminescence emissions that are visible to the unaided human eye and one or more may have intrinsic luminescence emissions that are invisible to the unaided human eye, for example infra-red (IR) or ultra-violet (UV) luminescence emissions. Similarly, one or more of these different rare earth dopants may have intrinsic resonant electromagnetic emissions that are visible to the unaided human eye and one or more may have intrinsic resonant electromagnetic emissions that are invisible to the unaided human eye, for example infra-red (IR) and/or radio-frequency (RF) and/or ultra-violet (UV) resonant electromagnetic emissions.

The combined effect of the host and the rare earth dopant may be such as to cause the marker, such as a security marker, for example, to emit light that is visible by the unaided eye, for example in the range of about 390-700 nm. The marker, such as a security marker, for example, may be excited by highly selective, high intensity visible light and the resultant emission may be in the visible region.

It may be desirable to add secondary dopants (such as other rare earth elements) to a host including primary dopants (i.e., those dopants that have already been introduced into the host to produce luminescence and/or resonant electromagnetic emission at the pre-selected wavelength) even though the emissions from these secondary dopants are not conducive to the desired transitions (i.e., the luminescence and/or resonant electromagnetic emission at the pre-selected wavelength). This is because the energy levels of these secondary dopants may contribute to otherwise prohibited transitions. Thus, the secondary dopants do not luminescence and/or resonantly electromagnetically emit at the pre-selected wavelength, but rather they may contribute indirectly by strengthening the luminescence and/or the resonant electromagnetic emission from the primary dopants at the pre-selected wavelength.

Various ratios and concentrations of dopants have been tested. In one example, the doping used was about 3 mol %, based upon the total number of moles of oxides and dopants in the composition. About 1 to 3 mol % is used for single and multi doped beads of glass (i.e., 1 mol % Eu, 1 of Tb 1 of Dy for 1 bead in steps (of each) of 0.5 mol % up to 2 mol % Eu, 3 mol % Tb and 3 mol % Dy). Bead size was about 50 microns (for screen printing). One type of glass used in this example has a soft point of about 740 degrees C., although the exact melting point depends on the specific glass used, and may vary from about 700 degrees C. to about 1500 degrees C. For some embodiments, efficiency may level off for doping above 3 mol %.

Different methods of doping glass with rare earth elements are known. The following patents and/or published applications describe various doping methods, and are hereby incorporated by reference: U.S. Pat. No. 6,153,339; U.S. Pat. No. 5,262,365; and US Published Application 2004/0212302.

Glass beads have been fabricated and tested (luminescent spectra have been measured) for beads varying from 5 μm in diameter (which is a suitable size for incorporating in inkjet fluid) to 100 μm in diameter (which is a suitable size for screen printing applications). To obtain beads having a size of approximately 5 μm, the beads may be passed through a micro sieve having 6 μm apertures/reticulations.

According to various further aspects, an item having an electromagnetically detectable feature, such as an optically detectable feature, such as a security feature, for example, for emitting electromagnetic radiation, such as light, at a pre-selected wavelength may be provided, the item comprising: a rare earth dopant and a host incorporating the rare earth dopant, the interaction of the host and the dopant being such as to provide a luminescent fingerprint and/or another electromagnetic response that is different from that of the rare earth dopant. The item may be validated by irradiating the item and detecting emissions at the pre-selected wavelength. The item may be a fluid. Examples of fluids particularly suitable for use may include fuel, paint, ink, and the like. The item may be a laminar media item. The laminar media item may be in the form of a web, or in sheet form. Examples of sheet form laminar media items may include banknotes and financial instruments such as checks, giros, and money orders. The item may include a plurality of markers, such as security markers, for example, each marker emitting at a different pre-selected wavelength. Alternatively, a marker may include a plurality of rare earth dopants.

In various illustrative embodiments, the markers may have different concentrations of dopant, so that the intensities of the pre-selected wavelength emissions may be different. By virtue of this feature, the relative emission intensity of different pre-selected wavelengths may be used as an identification and/or security feature. For example, one pre-selected wavelength intensity may be 100%, another pre-selected wavelength intensity 50%, a third pre-selected intensity 25%, and a fourth pre-selected intensity 50%. In various illustrative embodiments, more than four wavelengths may be used and in various alternative illustrative embodiments fewer than four wavelengths may be used. This may provide a large variety of identification and/or security profiles, where each profile may comprise a ratio of intensities of a plurality of wavelengths. This also makes counterfeiting even more difficult, as the quantities of each dopant must be accurately replicated, in addition to the carrier energy difference.

In various illustrative embodiments, the emission from each marker may decay over a different time period. By virtue of this feature, the time over which an emission occurs for a particular wavelength may be used as part of an identification and/or security profile.

According to various further aspects, a system for validating an item having an electromagnetically detectable feature, such as an optically detectable feature, such as a security feature, for example, emitting electromagnetic radiation, such as light, at one of a plurality of pre-selected wavelengths may be provided, where the security feature has a carrier incorporating a rare earth dopant, the system comprising: means for illuminating the optically detectable feature, such as the security feature, for example, with one or more wavelengths for producing emissions from the rare earth dopant; means for detecting emission from the optically detectable feature, such as the security feature, for example, at a pre-selected wavelength; means for filtering and comparing the detected emission with an identification and/or security profile for the item; and means for indicating a successful validation in the event of the emission matching the identification and/or security profile.

The means for illuminating the item may comprise a pulsed light emitting diode (LED), a laser diode, or a filtered broadband light source, and an illumination filter for ensuring that only a narrow band of wavelengths illuminate the item. The means for detecting emission may comprise a detection filter to filter out all wavelengths except the pre-selected wavelength, and a photodiode to detect the intensity of light passing through the detection filter. various illustrative embodiments, the illumination means may comprise an array of LEDs, each LED having a different illumination filter, so that the item to be identified and/or validated may be illuminated with multiple wavelengths. In such embodiments, the detection means may comprise an array of photodiodes, each photodiode having a different detection filter, so that the emission at each pre-selected wavelength may be determined.

According to various further aspects, a method of validating an item having an electromagnetically detectable feature, such as an optically detectable feature, such as a security feature, for example, emitting electromagnetic radiation, such as light, at one of a plurality of pre-selected wavelengths may be provided, the method comprising: illuminating the security feature with electromagnetic radiation, such as light, at one or more wavelengths for producing emissions from the rare earth dopant; detecting emission from the identification and/or security feature at a pre-selected wavelength; filtering and comparing the detected emission with an identification and/or security profile for the item; and indicating a successful validation in the event of the emission matching the identification and/or security profile.

According to various further aspects, an electromagnetically detectable marker, such as an optically detectable marker, such as a security marker, for example, for emitting electromagnetic radiation, such as light, at a pre-selected wavelength may be provided, the marker comprising: a rare earth dopant incorporated within a host material, the dopant and the host material being such as to cause emission of electromagnetic radiation in response to electromagnetic stimulation by electromagnetic radiation of a pre-determined wavelength, such as emission of visible light in response to optical stimulation by visible light of a pre-determined wavelength, for example. The interaction of the host and the dopant may be such as to provide a luminescent fingerprint and/or a resonant electromagnetic response and/or another electromagnetic response that is different from that of the rare earth dopant.

According to various further aspects, a security item that includes an electromagnetically detectable marker, such as an optically detectable marker, such as a security marker, for example, for emitting electromagnetic radiation, such as light, at a pre-selected wavelength may be provided, the marker comprising a rare earth dopant incorporated within a host material, the dopant and the host material being such as to cause emission of visible light in response to optical excitation by visible light. The security item may be a fluid, for example fuel, paint, ink and the like. Alternatively the security item may be a laminar media item, for example banknotes and financial instruments such as checks. The item may include a plurality of security markers, each marker emitting at a different pre-selected wavelength. The interaction of the host and the dopant may be such as to provide a luminescent fingerprint and/or a resonant electromagnetic response and/or another electromagnetic response that is different from that of the rare earth dopant.

According to various further aspects, an electromagnetically detectable marker, such as an optically detectable marker, such as a security marker, for example, for emitting electromagnetic radiation, such as light, at a pre-selected wavelength may be provided, comprising a borosilicate based glass. In various illustrative embodiments, the glass may include SiO₂; NaO; CaO; MgO; Al₂O₃; FeO and/or Fe₂O₃; K₂O, and B₂O₃, and a rare earth dopant, such as a lanthanide. In various illustrative embodiments, the glass may have a composition of: SiO₂ 51.79 wt %; NaO 9.79 wt %; CaO 7.00 wt %; MgO 2.36 wt %; Al₂O₃ 0.29 wt %; FeO and/or Fe₂O₃ 0.14 wt %; K₂O 0.07 wt %, and B₂O₃ 28.56 wt %, not precluding the use of other glass mixes. The glass and the rare earth ion may be formed into a micro-bead. The micro-bead can be formed of almost any conductive element, such as aluminum rods. In one preferable embodiment, the micro-beads are composed, at least in part, of Buckminsterfullerenes.

The marker may comprise a host, such as glass or plastic including one or more types of rare earth ion. The interaction of the glass or plastic and the dopant may be such that the spectral response of the marker is different from that of the rare earth dopant or the host per se. In particular, the interaction between the host and the dopant may be such that the intrinsic energy levels of the dopant change when the dopant is incorporated into the host. For example, when the dopant is incorporated into a glass, new bonds are formed in the doped glass, thus altering the electron arrangement and, hence, the energy levels of absorption and luminescent emission and/or resonant electromagnetic emission response and/or other electromagnetic emission response. Altering the rare earth dopant and/or dopant chelate and/or the composition of the host changes these energy levels and, hence, the observed luminescent fingerprint and/or resonant electromagnetic response and/or another electromagnetic response. A currently preferred dopant is any of the lanthanides except Lanthanum. The rare earth doped glass may be formed into micro-beads that may be included in, for example, a fluid such as ink.

According to various further aspects, a kit may be provided comprising a) a collection of samples derived from a single batch of material, all samples producing a common response signature when illuminated by a set of excitation frequencies, and b) a scanner for illuminating a test sample with the set of excitation frequencies and/or exposing a test sample to electromagnetic radiation of the appropriate set of excitation frequencies and ascertaining whether the test sample produces the response signature. The scanner may include data indicating the response signature, and may compare a signature obtained from the test sample with the data. The scanner i) may include one of the samples as a reference, ii) may obtain a signature from the reference, iii) may obtain a signature from the test sample, and iv) may compare the two signatures.

Several methods for doping standard glass compositions with the selected luminescent rare earth atoms and/or resonant electromagnetic rare earth atoms and/or otherwise electromagnetically responsive rare earth atoms may be employed. As used herein, the word “dopant” refers to (i) additives (for example, rare earth elements) introduced to the host components before the host (for example, glass) is produced, so that when the host is produced the host contains the additives, which is referred to herein as a “pre-production dopant,” and/or (ii) additives introduced to the host after the host is produced, so that the host is produced without the additives present, which is referred to herein as a “post-production dopant.” Thus, the term dopant may cover additives introduced either before the host is produced (a pre-production dopant) or after the host is produced (a post-production dopant).

In one method, test samples of doped glass may be prepared by the incorporation of the rare earth atoms into the batch composition using the appropriate metal salt. The glass may be prepared by heating the batch in a platinum crucible to above the melting point of the mixture. In another method, existing standard glass samples may be powdered and mixed with solutions of the luminescent and/or resonant electromagnetic ions. The glass may be lifted out of the solvent, washed, and then oven dried.

An example of a glass that may be used as the carrier material for the rare earth dopants is a borosilicate based glass. In particular, a glass that may be used is as follows: SiO₂ 51.79 wt %; NaO 9.79 wt %; CaO 7.00 wt %; MgO 2.36 wt %; Al₂O₃ 0.29 wt %; FeO and/or Fe₂O₃ 0.14 wt %; K₂O 0.07 wt %, and B₂O₃ 28.56 wt %. This may be made by ball milling soda lime beads (100 μm) for about 5 minutes to create a powder to help melting and mixing. Then about 5 g of the crushed soda lime beads, about 2 g of the B₂O₃ and about 3 mol % of the rare earth dopant, for example, Europium, Dysprosium, and Terbium, but also others, may be ball milled together for, for example, about 3 minutes. The resulting powder may then be put in a furnace and heated up to about 550 C. The resulting powder may then be left in the furnace at this temperature for about 30 minutes, to ensure that the boric oxide is completely melted. Then, the temperature may be increased to about 110° C. for about 1 hour to produce a homogeneous melt. The temperature may be increased again to about 1250 C and the molten glass is poured into a brass mould, which is at about room temperature, which quenches the glass to form a transparent, bubble free borosilicate glass, doped with rare earth atoms.

The peak emission wavelength for luminescent and/or resonant electromagnetic emission in the marker may depend on the energy levels of the final rare earth doped host. Altering the weight percentage of the network modifier oxides within the glass matrix may change these energy levels and, hence, change the observed peak fingerprint. Hence, to observe the correct wavelength fingerprint, the glass composition has to be known. Likewise, where two or more rare earth dopants are used, varying the ratios, by mole percentage, of these may change the luminescence and/or resonance electromagnetic intensity in the detected signal. Peak intensities may also be used as part of an encoding scheme and so, by varying the dopant levels, there may be provided an opportunity to provide even more encoding options.

Moreover, the method and system disclosed herein, for marking at least one product and/or for indicating marking information for at least one product, provides a method and/or a system allowing at least one person, for example a visually impaired person, to “read” marking information for at least one product and/or at least one package for the at least one product. Furthermore, the method and system disclosed herein, for marking at least one product and/or for indicating marking information for at least one product, provides a method and/or a system that increases security. Other technical advantages will be apparent to those of ordinary skill in the art having the benefit of the present disclosure and in view of the following specification, claims, and drawings.

### BRIEF DESCRIPTION OF THE DRAWINGS

The following figures form part of the present specification and are included to further demonstrate certain aspects of the present invention, and should not be used to limit or define the present invention. The present invention may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which the leftmost significant digit(s) in the reference numerals denote(s) the first figure in which the respective reference numerals appear, wherein:

FIG. 1 schematically illustrates a diagram showing processing of various illustrative embodiments, according to teachings of the present disclosure;

FIG. 2 schematically illustrates four excitation wavelengths, and the response produced by each, according to teachings of the present disclosure;

FIG. 3 schematically illustrates an excitation frequency F1 and a response frequency F2, according to teachings of the present disclosure;

FIG. 4 schematically illustrates the decay over time of response frequency F2 shown in FIG. 3;

FIG. 5 schematically illustrates a time delay DEL-T that may exist between the excitation frequency F1 and the response frequency F2;

FIG. 6 schematically illustrates sequential excitation by four excitation frequencies, according to teachings of the present disclosure;

FIG. 7 schematically illustrates part of a database, according to teachings of the present disclosure;

FIG. 8 schematically illustrates a conventional table of energy levels of various dopants in silicon;

FIG. 9 schematically illustrates a computer storing a database that is accessible by a remote computer, according to teachings of the present disclosure;

FIG. 10 schematically illustrates various illustrative embodiments implemented in connection with a photocopier, according to teachings of the present disclosure;

FIG. 11 schematically illustrates a varnish in which glass particles in various illustrative embodiments may be suspended, according to teachings of the present disclosure;

FIG. 12 schematically illustrates a coating on an article, which coating may contain glass particles in various illustrative embodiments, according to teachings of the present disclosure;

FIG. 13 schematically illustrates a carrier supporting a glass fragment in various illustrative embodiments, according to teachings of the present disclosure;

FIG. 14 schematically illustrates a carrier on which glass beads may represent data in various illustrative embodiments, according to teachings of the present disclosure;

FIG. 15 schematically illustrates a kit in various illustrative embodiments, according to teachings of the present disclosure;

FIG. 16 schematically illustrates a scanner in various illustrative embodiments, according to teachings of the present disclosure;

FIG. 17 schematically illustrates a block diagram of a detector arrangement in various illustrative embodiments, according to teachings of the present disclosure;

FIG. 18 schematically illustrates a table showing various excitation wavelengths and corresponding emission wavelengths for a Europium dopant in a borosilicate based glass in various illustrative embodiments, according to teachings of the present disclosure;

FIG. 19 schematically illustrates a table similar to that of FIG. 18 for Europium, but in solution, according to teachings of the present disclosure;

FIG. 20 schematically illustrates a diagram of a system in which a method for marking at least one product and/or for indicating marking information for at least one product may be used in various exemplary embodiments, according to teachings of the present disclosure; and

FIG. 21 schematically illustrates an exemplary method for marking at least one product, according to teachings of the present disclosure.

It is to be noted, however, that the appended drawings illustrate only typical embodiments of the present invention and are, therefore, not to be considered limiting of the scope of the present invention, as the present invention may admit to other equally effective embodiments.

### DETAILED DESCRIPTION OF EXEMPLARY EMBODIMENTS OF THE INVENTION

Illustrative embodiments of the present invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

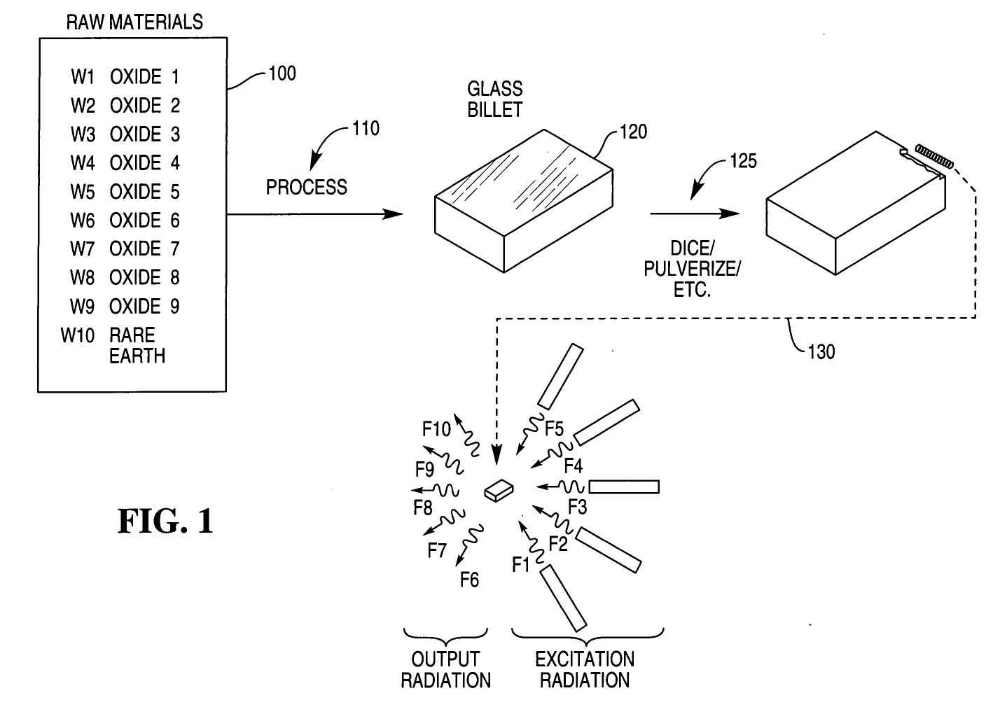

FIG. 1 schematically illustrates a diagram showing processing of various illustrative embodiments, according to teachings of the present disclosure. FIG. 1 schematically illustrates at 100 a collection of two types of raw materials: (1) a group of oxides and (2) one or more rare earth elements. The labels W, such as W1, indicate that each raw material is present in a specific weight percentage. Thus, the collective labels W1, W2, . . . , W10 indicate a specific composition, by weight percentage, of the raw materials.

The raw materials may undergo heat treatment and possibly annealing, as indicated by the arrow 110 labeled PROCESS, to produce a glass billet 120. The glass billet 120 may then be cut into dice, and/or pulverized, and the like, as indicated by the arrow 125 labeled DICE/PULVERIZE/ETC. Dotted arrow 130 points to a block that represents one of the dice, or a collection of the powder. In the general case, when the block 130 is excited by radiation, as indicated by electromagnetic radiation having frequencies F1 through F5, the block 130 will re-radiate output electromagnetic radiation having specific frequencies, as indicated by frequencies F6 through F10. The specific re-radiated frequencies, and also other properties of the electromagnetic radiation having those re-radiated frequencies, may be unique to the specific glass billet 120. The properties of the electromagnetic radiation having those re-radiated frequencies are described in detail below, but may include (1) the intensity of the electromagnetic radiation at each re-radiated frequency and (2) the decay rate of the electromagnetic radiation at each re-radiated frequency.

In various illustrative embodiments, in general, if the relative weight percentages W are altered, different re-radiated electromagnetic radiation with different frequencies, and/or with different other properties, may be detected. Also, if the heat treatment, annealing, or both, of the glass billet 120 are changed, then different re-radiated electromagnetic radiation with different frequencies, and/or with different other properties, may also be detected, even if the compositions of two billets 120 are otherwise identical. Therefore, in various illustrative embodiments, in the general case, the re-radiated electromagnetic radiation with their frequencies and their other properties, obtained from a given set of excitation electromagnetic radiation with their respective frequencies, may depend on (1) the composition, that is, the relative weight percentages W, (2) the heat treatment, and/or (3) the annealing (if any) of the glass billet 120.

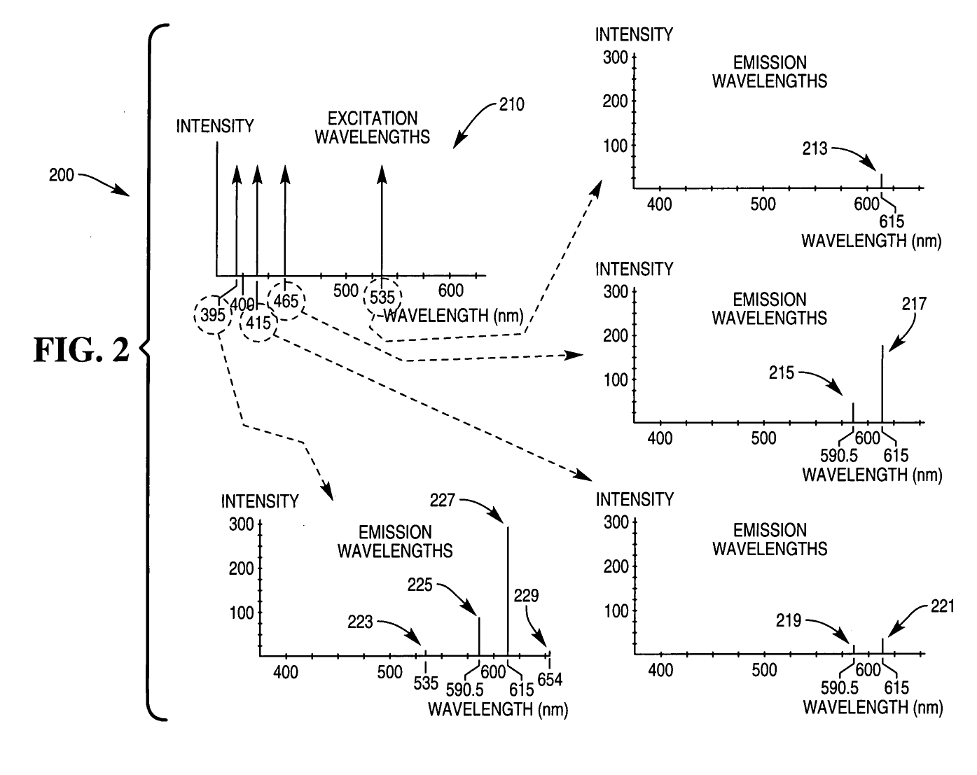

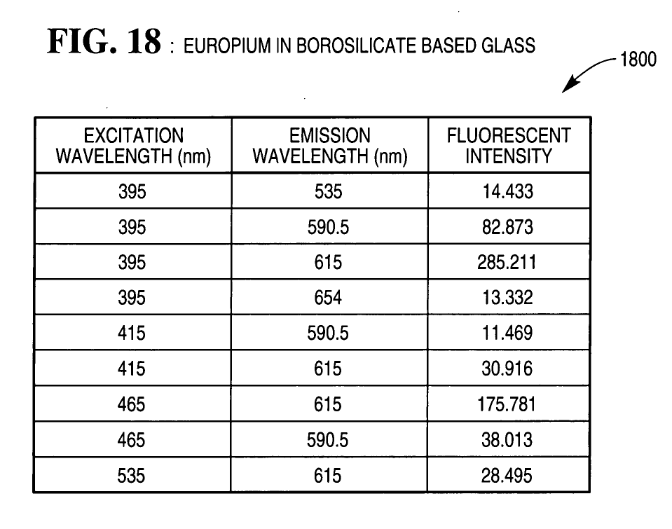

FIG. 2 schematically illustrates a generalized example of the response of a particular glass billet, such as the glass billet 120, and is based on FIG. 18, described in more detail below. Image 210 indicates four excitation wavelengths, at 395, 415, 465, and 535 nanometers (nm), respectively. For the glass billet in question, the 535 nm excitation electromagnetic radiation produces re-radiated electromagnetic radiation with emission wavelength 213, of relative intensity indicated. The 465 nm excitation electromagnetic radiation produces re-radiated electromagnetic radiation with emission wavelengths 215 and 217, of relative intensities indicted. The 415 nm excitation electromagnetic radiation produces re-radiated electromagnetic radiation with emission wavelengths 219 and 221, of relative intensities indicated. The 395 nm excitation electromagnetic radiation produces re-radiated electromagnetic radiation with emission wavelengths 223, 225, 227, and 229, of relative intensities indicated. FIG. 18 sets forth the relative intensities more precisely, in numerical form.

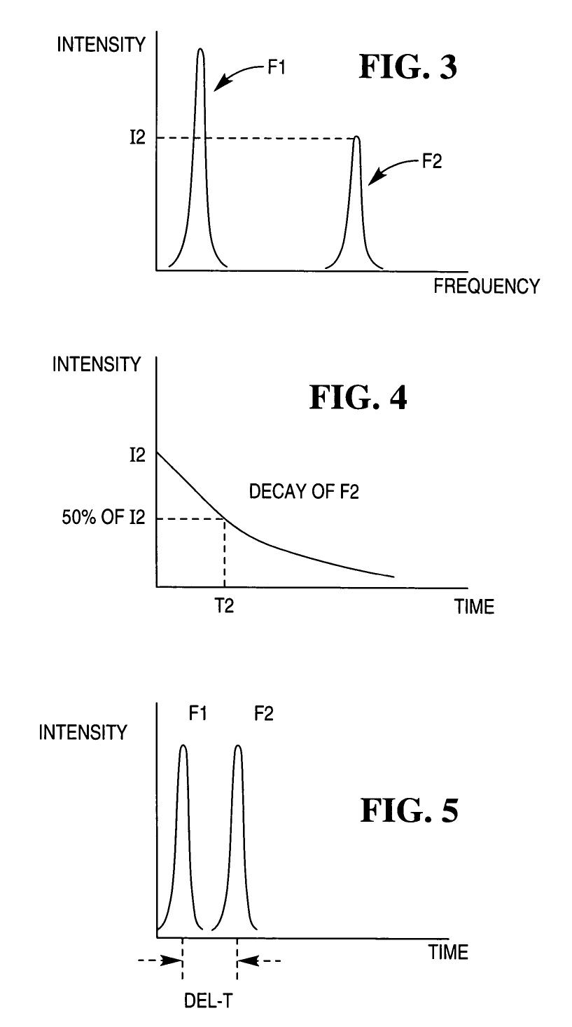

FIG. 3 schematically illustrates the general principle that excitation electromagnetic radiation having a frequency F1 may produce electromagnetic radiation having at least one re-radiated, or output, frequency F2. The frequency F2 may be characterized by an initial intensity, indicated by 12. Also, as indicated in FIG. 4, the electromagnetic radiation having the output frequency F2 may be characterized by a decay time, such as T2, which is the time required for the intensity of the electromagnetic radiation having the output frequency F2 to decay to 50 percent (50%) of the initial value of the intensity I2.

In addition to the decay time T2, another time interval may be present, such as that shown in FIG. 5. The electromagnetic radiation having the output frequency F2 may occur after a time interval DEL-T following the excitation electromagnetic radiation having the frequency F1. This delay time DEL-T may also be a property of the electromagnetic radiation having the output frequency F2, and may also be used to identify the glass billet, such as the glass billet 120.

In addition, the delay time DEL-T may be used to solve a particular problem that may arise. Note that, in FIG. 2, the excitation electromagnetic radiation having the wavelength of 395 nm may produce output electromagnetic radiation having the wavelength of 535 nm, as shown by the emission wavelength 223, for example. However, that output wavelength of 535 nm also corresponds to an excitation wavelength of the same value (535 nm). Thus, if the four excitation wavelengths in the image 210 were applied simultaneously, a problem could arise in determining whether a detected signal at the wavelength 535 nm was caused by the excitation at that wavelength or by the response 223.

One solution to this problem, in various illustrative embodiments, may be to utilize the time delay DEL-T of FIG. 5. The excitation wavelengths may be first applied, allowed to decay, and then a detector may be activated after the time delay DEL-T expires. Then, it is known that, if a signal at the wavelength 535 nm is detected, this not due to an excitation at that wavelength, but rather must be from the response 223.

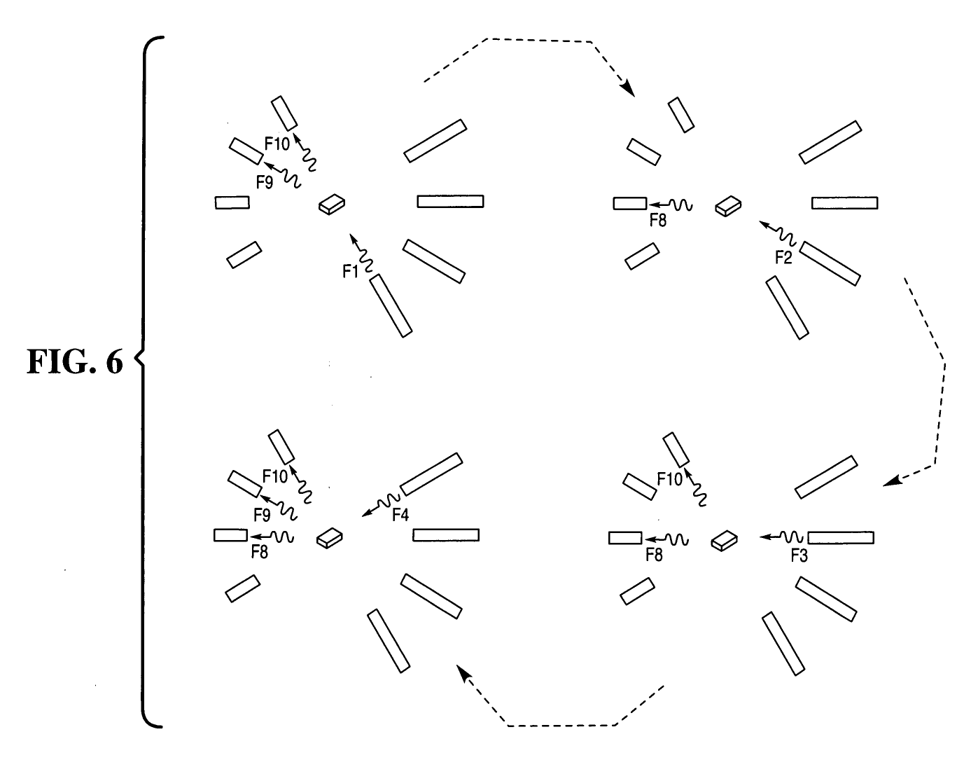

In addition, another solution to the problem, in various illustrative embodiments, may be to apply the excitations sequentially, as indicated by the sequence F1 through F4 in FIG. 6, for example. When each excitation electromagnetic radiation of a specific frequency is applied, a detector looks for a response, either at substantially the same time, or, alternatively, after a delay such as the time delay DEL-T in FIG. 5.

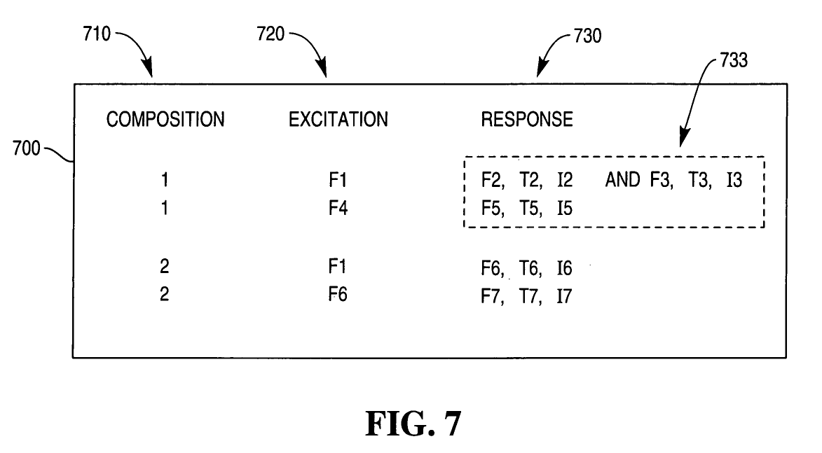

The principles just described may be used to construct a database 700 in FIG. 7. The column 710 labeled COMPOSITION refers to a specific billet, such as the glass billet 120, which contains a specific set of relative weight percentages of components, and which may have been subjected to specific heat treatment and annealing, or other specific processing. Heat treatment refers to the time-temperature history of the billet, such as the glass billet 120, in fusing the oxides and the rare earth element(s) together. Annealing refers to the time-temperature history of the billet, such as the glass billet 120, following heat treatment. Of course, in some cases no annealing may be used and/or air quenching may be viewed as an annealing. The column 720 labeled EXCITATION refers to the frequency of the electromagnetic excitation radiation applied to the billet, such as the glass billet 120, or a sample of the billet, such as the sample 130 of the glass billet 120, for example. In the case of COMPOSITION 1, two excitation frequencies F1 and F4 may be indicated. Similarly, in the case of COMPOSITION 2, two excitation frequencies F1 and F6 may be indicated.

The column 730 labeled RESPONSE refers to the frequency, decay time, and initial intensity of signals re-radiated in response to the electromagnetic radiation having the respective excitation frequency. For example, in the case of COMPOSITION 1, the excitation frequency F1 may produce re-radiated electromagnetic radiation, such as light, for example, of frequency F2, initial intensity I2, and decay time T2 and also re-radiated electromagnetic radiation, such as light, for example, of frequency F3, initial intensity I3, and decay time T3. In addition, excitation frequency F4 may produce re-radiated electromagnetic radiation, such as light, for example, of frequency F5, initial intensity I5, and decay time T5. Similarly, in the case of COMPOSITION 2, the excitation frequency F1 may produce re-radiated electromagnetic radiation, such as light, for example, of frequency F6, initial intensity I6, and decay time T6. Likewise, in addition, excitation frequency F6 may produce re-radiated electromagnetic radiation, such as light, for example, of frequency F7, initial intensity I7, and decay time T7.

The specific definitions of intensities, such as 15, and decay time, such as T5, are here chosen for convenience. Other definitions may be possible, and values other than initial intensity and 50 percent (50%) decay-time may be used. Also, if a delay time, such as DEL-T in FIG. 5, is found significant for a particular billet, such as the glass billet 120, and excitation frequency, that delay time may be included in the database 700, and may be deemed represented by the times such as T2, T3, and the like.

The collection of responses may be viewed as a signature that identifies each billet, such as the glass billet 120, or each sample of the billet, such as the sample 130 of the glass billet 120, for example. For example, The responses in dashed box 733, for example, may represent one signature of a billet, such as the glass billet 120, of COMPOSITION 1. Alternatively, a sub-set of the contents of dashed box 733 may be used. For example, the excitation frequency F1 alone may be used for COMPOSITION 1, and frequency F4 may be eliminated.

Several features that distinguish the glass dice 130 of FIG. 1 from conventional taggants may be one or more of the following features. One feature may be that it may be difficult to reverse-engineer the dice 130. That is, it is difficult for one to excite the glass 120 and/or 130, as indicated in FIGS. 1 and 2, for example, detect the output signature, and then fabricate a glass that reproduces that output signature. One reason is that a complete database 700 of the type shown in FIG. 7 is not known to exist. That is, a complete database 700 that covers all possible compositions of glass billets, and their signatures, is not known to be available in the published literature, including printed publications as defined by 35 USC section 102.

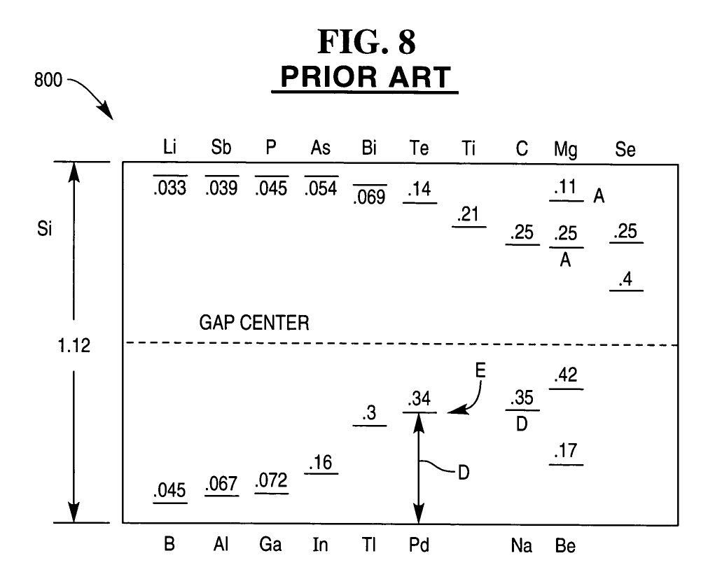

This fact distinguishes various illustrative embodiments according to the present disclosure from conventional systems that may appear to be similar, but are not. For example, a silicon crystal may be doped with different elements. The doped silicon may then be excited, and radiated light of frequency corresponding to the doping element may be detected. Based on the frequency of the re-radiated light, one may consult known tables, and determine the identity of the dopant. FIG. 8 illustrates such a conventional table 800 for silicon. The frequency of re-radiated light may depend on the drop in energy D experienced by an electron, and that drop in energy D may depend on the energy level E created by the dopant. One may thus reproduce the silicon-dopant system, based on the conventional table 800 for silicon. However, such tables are not known to exist for the glass systems in various illustrative embodiments according to the present disclosure.

Another feature is that the glass systems, such as the glass billet 120, or a sample of the billet, such as the sample 130 of the glass billet 120, for example, in various illustrative embodiments according to the present disclosure are not crystalline. Glasses, in general, are supercooled liquids and are not crystals. Thus, an energy level system corresponding to the conventional table 800 for silicon, as shown in FIG. 8 for crystalline silicon, may not be present in the same form, and, if present at all, may be different for each of the different glasses described herein.

Another feature is that some glasses may be classified as refractory materials. The dice and/or powders, such as the sample 130, of such glasses, such as the glass billet 120, may be able to withstand high temperatures. Such glasses may be unaffected by temperatures of 400, 500, 700, 1000 degrees F., and higher. This distinguishes such glasses and/or dice and/or powder from most, if not all, conventional luminescent inks and paints, and the surfaces to which such conventional luminescent inks and paints may be applied.

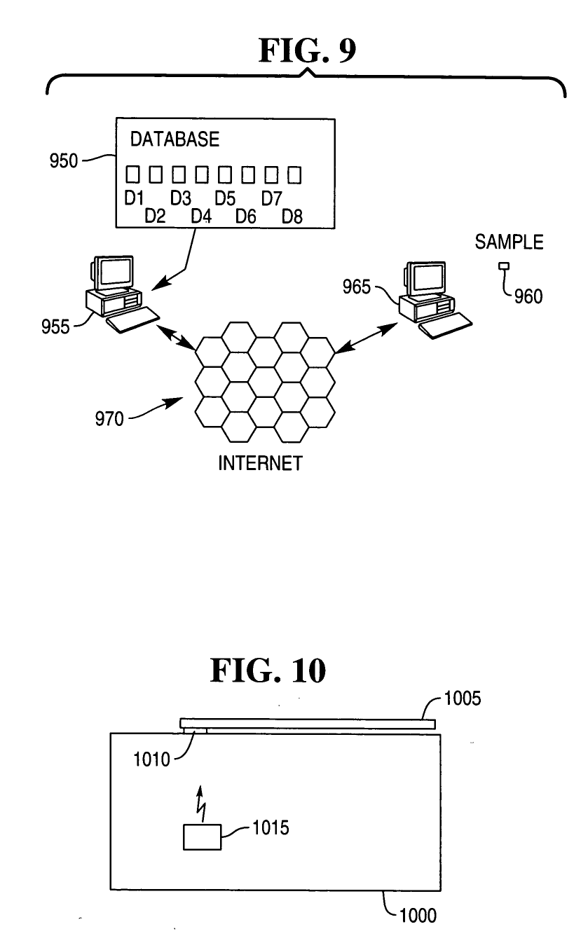

Several applications of the glasses under consideration may be discussed below. In FIG. 9, for example, a database 950 may be stored in a computer 955. The database 950 may be generated by a glass foundry (not shown) that fabricated the glass billet 120 in FIG. 1. The glass foundry may have subjected the glass billet 120 and/or the fragments 130 of the glass billet 120, to various excitation frequencies, and may have measured the signature of the glass billet 120. Data concerning the glass billet 120, such as the composition, heat treatment, annealing, excitation frequencies and/or resulting signatures, may be stored in the database 950, as indicated by blocks D1, D2, . . . , D8. The identity of the foundry may be included in the data. The glass foundry may repeat the process for another billet of glass, of a different composition, for example. A user (not shown) may test a sample 960 of the glass billet. For example, the sample 960 may be attached to a specific article (not shown). The user may apply electromagnetic radiation having one or more excitation frequencies to the sample 960, and obtain a signature of the sample 960. FIG. 2 illustrates generalized excitation frequencies in the image 210, and the signature(s) that may result. The signature obtained from the sample 960 may be represented as a collection of data that the user may transmit to the computer 955 in FIG. 9 over the INTERNET 970, using the user's own computer 965, for example. As the database 700 in FIG. 7 indicates, knowledge of the signature may allow one to ascertain the composition of the glass 120 from which the sample 960 in FIG. 9 may have originated, and/or any other data associated with the data in the database 950, such as the identity of the foundry which fabricated the glass 120.

In addition, other information may be included in the database 950 in FIG. 9. For example, a billet 120 having a given signature may be transferred to a specific party, such as a government. That party may be identified in the database 950, in connection with the data regarding the billet 120. As a more specific example, the fragments 130 of the billet 120 may be pulverized and added to an ink that is used to print currency. If a sample 960 in FIG. 9 is taken from the currency, and points to the specific billet 120, then it is known that the currency is associated with the billet 120 delivered to the particular government. Thus, in general, the sample 960 in FIG. 9 of the billet 120 may be used to trace the origin of the sample 960. Additionally, and/or alternatively, the database 950 in FIG. 9 may indicate the original owner of the billet 120 from which the sample 960 may have been derived.

In another application, the glass 120 may be used to suppress counterfeiting and/or copying. FIG. 10 schematically illustrates a photocopier 1000. A sheet 1005 to be copied, which may take the form of a visual image on a paper carrier, may be disposed on the photocopier 1000. A fragment 1010 of the glass 120 may be disposed on and/or attached to the sheet 1005. A detector 1015 may illuminate the sheet 1005 at the copying station of the photocopier 1000, and, thereby, may also illuminate the fragment 1010 of the glass 120. If the fragment 1010 of the glass 120 produces a particular signature, then the detector 1015 may block copying, for example, so that the photocopier 1000 may not copy the sheet 1005.

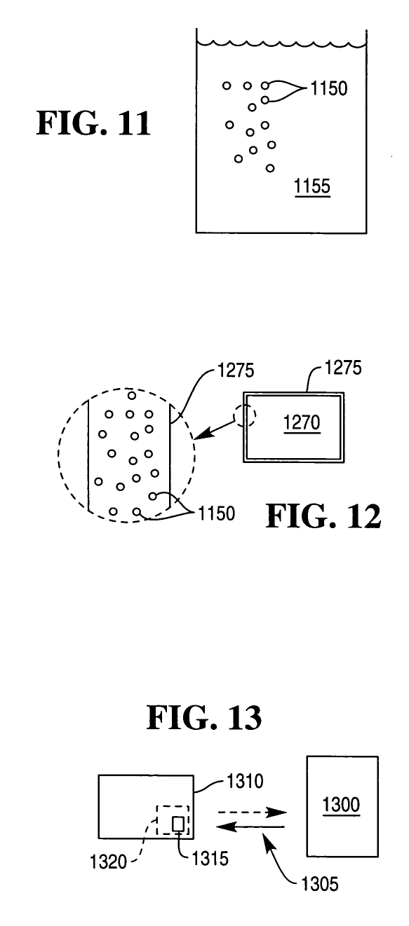

In another application, FIG. 11 schematically illustrates fragments 1150 of the glass 120 that may be added to a liquid and/or a solid carrier 1155, such as a varnish, ink, lacquer, paint, adhesive, paper, plastic, and the like. In various illustrative embodiments, the fragments 1150 may take the form of a fine powder, and may have no dimension larger than about one micron, five microns, ten microns, fifteen microns, and/or twenty microns, for example. In various illustrative embodiments, the powder 1150 may be sufficiently fine that the granules may be invisible to the naked eye. In various other illustrative embodiments, the grains of the powder 1150 may be approximately the size of the grains of common table salt. In various particular illustrative embodiments, each grain 1150 may be in the form of a generally spherical bead having a diameter of approximately five microns, for example, in one case.

The liquid carrier may be painted onto an article 1270, as illustrated schematically in FIG. 12, forming a coating 1275. The signature of the particles 1150 may be detected in the manner described above, and the database 950 in FIG. 9 may be used to deduce information about the article 1270. The article 1270 may be a complex product (having many separate parts), where each part may be painted using paint including the fragments 1150. This may ensure that the entire product has the same signature, even though the product may be a composite of many parts, for example.

In various other applications, it may not be necessary to consult a database, such as the database 950. A detector, such as a reader, as described herein, may be equipped with data that may indicate a signature of fragments 1150 from a glass billet 120. Additionally, and/or alternatively, the data may indicate multiple signatures, for multiple billets 120.

In use, an article 1310, as shown in FIG. 13, for example, may carry at least one glass fragment 1315 within, optionally in a marker 1320 (shown in phantom), and may be submitted to a detector 1300. The detector 1300, such as a reader 1300, for example, may obtain the signature of the fragment 1315, as indicated at 1305, and, if the signature matches a stored signature, the detector 1300 may deduce information about the article 1310. Such information may relate to authenticity, origin, ownership (including chain of custody) information about the article 1310, and/or any other characteristic that possession of the fragment 1315 and/or the marker 1320 having the fragment 1315 disposed within and/or thereon, having a predetermined signature may represent.

For example, the article 1310 may take the form of a document (such as a passport, visa, customs sheet, will, stock certificate, certificate of authenticity, boarding pass, receipt, invoice, prescription, a standard form, an operator's license, and the like), an item of fine art, a label, a registration plate and/or card for a vehicle and/or other item commonly registered with a government, a written signature and/or fingerprint carried on a card, and/or a storage medium such as a CD, DVD, and/or floppy disc, and the like. If the fragment 1315 displays a specific signature, then that signature may indicate that the article 1310 may be copied, or is prohibited from being copied, as appropriate. The article 1310 may also take the form of a credit card, debit card, charge card, loyalty card, telephone card, stored value card, and/or casino chip, and the like. If the article 1310 is a form, the article 1310 may include a universal resource locator (URL), or some other link, encoded using the fragment(s) 1315, to allow a user to ascertain the source of the form and/or a location from which to obtain one or more new forms.

As used herein, a spectral signature may relate to aspects of an emission spectrum obtain from an electromagnetically responsive material and/or an electromagnetically resonant material, such as a luminescent material, for example. These aspects may include one or more of: intensity at a particular wavelength, decay time of intensity at a wavelength, presence or absence of a peak at one or more wavelength, ratio between peaks, absolute intensity, relative intensity, and the like.

Markers 1320, such as security markers 1320, may be used to store information, in a similar way to how a CD and/or a DVD stores information, except that the markers 1320, such as the security markers 1320, become the bumps for encoding, thereby providing information storage, such as secure media. As another example, since different billets of glass 120 may produce different signatures, those signatures, and/or the corresponding billets 120, may act as identification numbers. These ID-glasses may be attached to, and/or embedded in, articles to indicate ownership. This concept is applicable to articles such as items of fine art, precious metals and jewelry, human tissues such as organs, semen, and blood, and/or certificates, and the like. As a specific example, an ID-glass may be inserted into a body fluid that is to be tested for illness, and/or presence of drugs and/or alcohol. The ID-glass, being inert to most common reagents, may not affect the test results, except perhaps by contaminating an optical test, which would be rare. The ID-glass may identify the owner of the fluid, for example.

As another example, an ID-glass may identify the origin of an article, and, thus, provide authentication. As a specific example, this may apply to items of fine art, liquors, perfumes, human tissues, admission tickets, and/or entertainment recordings, such as video tapes and discs, and the like. As another example, the ID-number feature of the ID glass may be used to classify articles and/or substances. As a specific example, ten different ID-glasses, with ten different signatures, may be fabricated. These may be used to distinguish ten ostensibly identical, yet different, articles. For example, contact lenses may look identical, but may be different. A tiny ID-glass at the edge may identify the contact lens. A similar principle may apply to blood type, pharmaceuticals, chemicals, and the like. Pharmaceuticals may be distinguished by including a unique signature on each type of medication. One or more fragments 1150, 1315 of the billet 120 may be incorporated in the outer coating of a medication. This would make it simple to distinguish between, for example, an analgesic and a medication that reduces blood clots. This allows automated medicine dispensers to distinguish reliably between different types of medication. Alternatively, and/or additionally, this unique signature may be incorporated in the packaging of the pharmaceuticals. Additional benefits may include more reliable drug dosage. For example, if each drug includes markings, such as security markings, having a signature unique for the day and/or time at which the drug is to be taken, then an absent-minded patient may use a reader to ascertain if they need to take a drug and/or if they have already taken the drug for that time/day. This may have applications in the home and/or in a pharmacy.

Another example relates to the food industry. Produce, such as fruit and vegetables (but also including tins, meat, milk, yoghurt, and the like), may be marked using glass particles 1150, 1315. The glass particles 1150, 1315 may be used instead of, and/or in addition to, adhesive stickers that are currently used on fruit. By using glass particles 1150, 1315, a unique signature may be applied to each type of produce item. For example, Gala apples may have one signature, Macintosh apples may have another signature, and so on. A checkout station may be equipped with the reader 1300 so that the produce may be automatically identified and/or the price obtained without having to read an adhesive label.

Glass particles 1150, 1315 having a unique signature may also be used in food additives, for example, in peanuts. This may allow a person who is allergic to, and/or otherwise intolerant of, the food additive to ascertain whether the food additive is present or not.

Environmental pollution and/or unauthorized dumping of waste may be detected and monitored by incorporating fragments 1150, 1315 of a billet 120 into a waste material. Each large waste-producing factory may be assigned a unique signature, and fragments 1150, 1315 having that signature may be incorporated into the waste produced. If this waste is detected in an area that should be free of pollution, then the source of this waste may be identified.

In another example, the markers 1320, such as the security markers 1320, may be used to determine concentrations of fluids or solids. For example, if two different fluids are mixed, then each fluid may have a unique signature. A first set of fragments 1150, 1315 having a first signature may be suspended in one fluid; and a second set of fragments 1150, 1315 having a second signature may be suspended in the other fluid. When the two fluids are combined, an electromagnetic response spectrum, such as an electromagnetic resonance spectrum, such as a luminescence spectrum, may be measured from the mixture of the two fluids. The intensity from the first signature may be compared with the intensity from the second signature to determine the ratio of the two fluids in the mixture, depending on the substantially complete dispersion of the respective sets of fragments 1150, 1315 having the first and/or second signatures in the respective different fluids and/or the miscibility of the respective different fluids and the respective sets of fragments 1150, 1315 having the first and/or second signatures, so that clumping of the respective sets of fragments 1150, 1315 having the first and/or second signatures in the respective different fluids may be avoided, for example.

A similar identification may perform a trademark-like function, in identifying authentic goods. Without limitation, this may apply to toner cartridges, fuels, tires, and/or any fungible articles in which the identity of the manufacturer and/or supplier may be important. One such example is integrated circuits. These may include a unique fragment 1150, 1315, and/or a unique marker 1320 including the unique fragment 1150, 1315, to identify the manufacturer, and/or they may include serial numbers formed from fragments 1150, 1315, and/or the markers 1320 including the fragments 1150, 1315, to identify the type of integrated circuit.

Security markers 1320 may be included in ink used to tattoo pets and/or other animals, so that a pet and/or another animal may use a tattoo as a secure identifier and/or to gain access to a restricted site or area. Security markers 1320 may be included in military uniforms, thereby enabling identification of a soldier by the uniform that he/she is wearing.

As another example, the ID-glass may be used to track articles. For example, a fuel tank at a gasoline filling station may acquire a leak. If an ID-glass powder 130, 1150, 1315 is added to the fuel tank, the powder 130, 1150, 1315 may migrate to the leak and escape. A detector 1300 may be used to elicit the powder 130, 1150, 1315 to display the signature of the powder 130, 1150, 1315, and/or to locate the leak.

This tracking function may be applied to people, animals, weapons, explosives, medical instruments, pollutants, and watercourses. It may also be applied to any article or substance generally that moves, and whose motion is to be followed, such as blood in the human circulatory system and/or food in the human digestive system.

In the case of treating the article 1310 as an animal, the tag 1315, if exhibiting the proper signature, may act as an admission permit and/or key. Thus, the tag 1315 may grant admission to places or buildings. Additionally, and/or alternatively, the tag 1315 may grant permission to use specific equipment.

In another application, the article 1310 of FIG. 13 may represent a person and/or other living being. The fragment 1315 having a predetermined signature may represent a specific characteristic, such as color-blindness.

In another application, the article 1310 in FIG. 13 may bear no visible tags, yet the coating may exhibit the signature when excited. Alternately, the coating may be applied only in a concealed location on the article 1310.

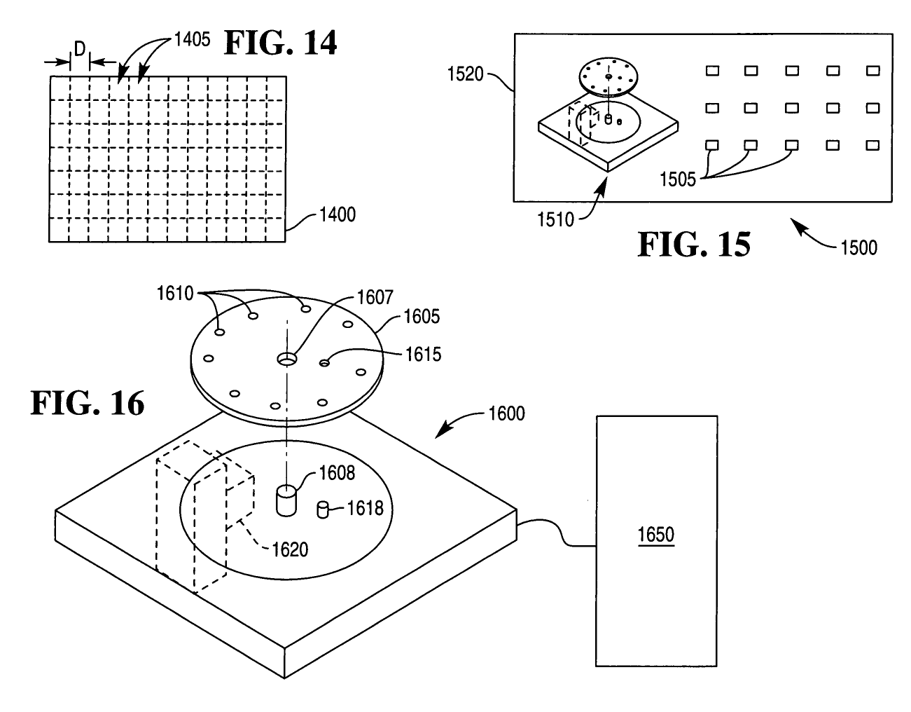

In another application, the glass fragments 130, 1150, 1315 may cooperate with each other to provide information. For example, FIG. 14 illustrates a card 1400, upon which is superimposed an imaginary grid. Distance D is pre-established by convention. If a glass fragment 130, 1150, and/or 1315 is positioned within a cell 1405 of the grid, that cell may be treated as a logical ONE. If the cell 1405 is empty, that is, devoid of a glass fragment 130, 1150, 1315, then that cell 1405 may be treated as a logical ZERO. A reader (not shown) may begin at a pre-established starting point, may advance in steps of distance D, and may determine whether a ONE or ZERO is present. A binary encoding system may thus be established.

Alternatively, glass fragments 130, 1150, and/or 1315 having two different signatures may used. Now the need to advance in units of D is eliminated, but may still be used, if desired. If the two different signatures are A and B, then the sequence AABAABBB may be treated as 11011000, which is another system of binary encoding.

This principle may be extended. If N types of glass fragment 130, 1150, and/or 1315 are used, having N different signatures, then an alphabet of N characters may thereby be made available.

Security markers 1320 may be incorporated into ink that is used to stain banknotes in the event of an attempted theft at an ATM. Conventional banknote staining systems are sold by a number of vendors, including Fluiditi®. The security marker 1320 may help law enforcement officers to trace banknotes that were stolen and/or stained because the stained banknotes would have a unique signature associated with the owner of the ATM.

Security markers 1320 may be used to revoke a permission previously granted. For example, if someone has a token that includes security markers having a signature that allows a user to access a restricted area or function, then an additional security marker 1320 (having a different signature) may be applied (sprayed, pressed, injected, and the like) to the token to modify the token. When the modified token is read, the presence of the new signature may act to deny access to the user.

Another example of the use of markers 1320, such as security markers 1320, for example, is in the field of guidance systems. Markers 1320, such as security markers 1320, for example, may be assigned signatures that correspond to directions, speed limits, and the like. These markers 1320 may be incorporated into the surface of a road, sidewalk, runway, deck, and/or pavement, to allow a pedestrian and/or a vehicle to (i) navigate, and/or (ii) ascertain advisory speeds and/or mandatory speed limits. One specific example may involve a blind or partially-sighted person who has a walking stick fitted with a marker reader, such as a security marker reader, for example, similar to the reader 1300, and a data-to-speech system. The surface of a pavement (sidewalk) may include a track having markers 1320, such as security markers 1320, for example, having one or more signatures indicating the direction of the pavement, the street name, the address at that particular location, and the like. As the blind person walks, he or she may use the walking stick to follow the track, and the data-to-speech system may translate the read signature data into a direction and/or a street name and/or the address at that particular location, and the like, using a look-up table stored in the data-to-speech system.

Another example may involve a vehicle fitted with a marker reader, such as a security marker reader, for example, similar to the reader 1300, aimed at a road surface. Markers 1320 in the road surface may include one or more signatures relating to the direction of the road, the destination of the road, the road name and/or number (for example, Interstate 70), and/or the speed limit of the road, and the like. The vehicle's marker reader, such as the security marker reader, for example, similar to the reader 1300, may be coupled to an entertainment center within the vehicle to provide an audible and/or visual readout to the vehicle driver and/or a passenger of the information stored in the road surface.

In another embodiment, a kit 1500 may be provided. The kit 1500 in FIG. 15 may contain a number of glass beads 1505. A detector 1510 may be provided, such as described below in connection with FIG. 16, and the detector 1510 may detect the specific signature(s) of the glass beads 1505. In ordinary practice, the detector 1510 may be dormant when contained within the kit 1500. All components of the kit 1500 may be contained in a common package, such as a thermo-formed blister pack.

The detector 1510 may compare the signature obtained from a sample bead 1505 with stored data indicating that signature. Alternatively, and/or additionally, the detector 1510 may be equipped with its own bead, and detector 1510 may compare the signature of that bead with the signature of a sample bead 1505.

In another embodiment, multiple different ID-glasses may be contained in the same article. The composite signature of all ID-glasses may be used for the purposes described herein.

In various illustrative embodiments, one billet of glass 120 may be fabricated and the signature of the one billet of glass 120 may be ascertained. This may be repeated for numerous billets, to develop a database of glasses 120 and their respective signatures, such as the database 700 and/or the database 950, for example.

In one approach, every time a new billet is fabricated, the signature of the billet may be compared with existing signatures in the database 700, 950. If the new signature does not deviate sufficiently from an existing signature, the corresponding billets may be treated as substantially interchangeable. Since the signatures may be, in effect, treated as numbers, a simple formula may be used to define similarity between signatures. For instance, if one signature has an electromagnetic radiative response having an emission wavelength and an intensity I, then another signature having an electromagnetic radiative response having an emission wavelength and an intensity of 0.951 may be defined as substantially similar.

In various illustrative embodiments, no database may be used. A glass foundry may fabricate a billet of glass 120, ascertain the signature of the billet of glass 120, divide the billet 120 into the fragments 130, 1150, 1315, 1505 and/or the powder 1150, and deliver the fragments/powder 130, 1150, 1315, 1505 to a customer. The foundry may include data indicating the signature, or the customer may rely on his or her own testing to deduce the signature. But the foundry may not retain data indicative of the signature, or, if the foundry does retain such data, may keep the data indicative of the signature secret. Alternatively, the data may not be available in a printed publication as defined in 35 USC section 102.

Thus, the customer may obtain a collection of ID-glass fragments that, as a practical matter, may be difficult to replicate. Alternatively, the customer may obtain a collection of ID-glass fragments that may at least be difficult to replicate by trial and error without undertaking about 10,000 trials, which may be considered an impractical number of trials.

The number of about 10,000 may be obtained as follows. Assume that the glass 120 may contain eight different components. Assume also that the final billet of the glass 120 may contain 1, 2, 3, . . . , 10 grams of each different component. Under these assumptions, the final billet may weigh from eight grams (one gram of each different component) to 80 grams (ten grams of each different component), and any integral number of grams in-between.

The total number of possible combinations of components may be about 10⁸ (10 raised to the eighth power). Note, however, that the combination 1-1-1-1-1-1-1-1 (one gram of each different component) may represent the same composition as the combination 2-2-2-2-2-2-2-2 (two grams of each different component), because the relative percentages of different ingredients may be the same. A similar comment applies to other multiples: 1-2-1-1-1-1-1-1 has the same relative percentages as 2-4-2-2-2-2-2-2, for example.

Nevertheless, these identical cases may represent a very small fraction of the total number of possibilities. In this example, of the about 10⁸ (about 100 million) total number of possible combinations of components there almost certainly exist at least about 10,000 different compositions, having at least about 10,000 different signatures, and perhaps as many as at least about 1.8 million different compositions, having at least about 1.8 million different signatures. Indeed, the number of distinct permutations of possible combinations is about equal to the product of the number of ways of choosing 8 different weight amounts (one for each component) from among the 10 possible weight amounts (1, 2, 3, . . . , 10 grams), which is 10 choose 8,

$$( \begin{matrix}10 \\ 8\end{matrix} ) = \frac{10 !}{8 ! ( 10 - 8 ) !} = \frac{10 !}{8 ! 2 !} = \frac{10 ⨯ 9}{2 ⨯ 1} = 45 ,$$

with the total number of permutations of the 8 different components, which is 8 factorial, 8!=8×7×6×5×4×3×2×1=40,320, so that the number of distinct permutations of possible combinations is about equal to 10 choose 8 times 8 factorial, which is

$$( \begin{matrix}10 \\ 8\end{matrix} ) 8 != \frac{10 !}{8 ! ( 10 - 8 ) !} 8 != \frac{10 !}{2 !} = 1 \text{,} 814 \text{,} 400 ,$$

among which are 10-9-8-7-6-5-4-3, 10-9-8-7-6-5-4-2, 10-9-8-7-6-5-4-1, 9-10-8-7-6-5-4-3, 9-8-10-7-6-5-4-3, and the like.

Generally, with n possible weight amounts (1, 2, 3, . . . , n grams) for r different components, the number of distinct permutations of possible combinations is about equal to the product of the number of ways of choosing r different weight amounts (one for each component) from among the n possible weight amounts (1, 2, 3, . . . , n grams), which is n choose r,

$$( \begin{matrix}n \\ r\end{matrix} ) = \frac{n !}{r ! ( n - r ) !} ,$$

with the total number of permutations of the r different components, which is r factorial, r!=r(r−1)(r−2)L (3)(2)(1)=∫₀^{∞}x^{r}e^{-x}dx, at least for any non-negative integer r, where 1!=1 and 0!=1, so that the number of distinct permutations of possible combinations is about equal to n choose r times r factorial, which is

$$( \begin{matrix}n \\ r\end{matrix} ) r != \frac{n !}{r ! ( n - r ) !} r != \frac{n !}{( n - r ) !} .$$

For example, considering only the subset of the number of distinct permutations of possible combinations when there are only 8 possible weight amounts (1, 2, 3, . . . , 8 grams), the subset of the number of distinct permutations of possible combinations, each of which weighs about 36 grams total, is about equal to the product of the number of ways of choosing 8 different weight amounts (one for each component) from among the only 8 possible weight amounts (1, 2, 3, . . . , 8 grams), which is 8 choose 8,

$$( \begin{matrix}8 \\ 8\end{matrix} ) = \frac{8 !}{8 ! ( 8 - 8 ) !} = \frac{8 !}{8 ! 0 !} = 1 ,$$

with the total number of permutations of the 8 different components, which is 8 factorial, 8!=8×7×6×5×4×3×2×1=40,320, so that the subset of the number of distinct permutations of possible combinations, each of which weighs about 36 grams total, is about equal to 8 choose 8 times 8 factorial, which is

$$( \begin{matrix}8 \\ 8\end{matrix} ) 8 != \frac{8 !}{8 ! ( 8 - 8 )} 8 != \frac{8 !}{8 ! 0 !} 8 != 8 != 40 \text{,} 320 ,$$

which by itself is already more than four times about 10,000 different compositions, among which are 8-7-6-5-4-3-2-1, 7-8-6-5-4-3-2-1, 7-6-8-5-4-3-2-1, 8-6-7-5-4-3-2-1, 6-7-8-5-4-3-2-1, and the like, having at least about 40,320 different signatures.

Similarly, considering the subset of the number of distinct permutations of possible combinations when there are only 9 possible weight amounts (1, 2, 3, . . . , 9 grams), the subset of the number of distinct permutations of possible combinations is about equal to the product of the number of ways of choosing 8 different weight amounts (one for each component) from among the only 9 possible weight amounts (1, 2, 3, . . . , 9 grams), which is 9 choose 8,

$$( \begin{matrix}9 \\ 8\end{matrix} ) = \frac{9 !}{8 ! ( 9 - 8 ) !} = \frac{9 !}{8 ! 1 !} = 9 ,$$

with the total number of permutations of the 8 different components, which is 8 factorial, 8!=8×7×6×5×4×3×2×1=40,320, so that the subset of the number of distinct permutations of possible combinations is about equal to 9 choose 8 times 8 factorial, which is

$$( \begin{matrix}9 \\ 8\end{matrix} ) 8 != \frac{9 !}{8 ! ( 9 - 8 ) !} 8 != \frac{9 !}{8 ! 1 !} 8 != 9 ⨯ 8 != 9 ⨯ 40 \text{,} 320 = 9 != 362 \text{,} 880 ,$$

which by itself is already more than 36 times about 10,000 different compositions, among which are 1-9-8-7-6-5-4-3, 1-9-8-7-6-5-4-2, 2-9-8-7-6-5-4-1, 9-1-8-7-6-5-4-3, 9-8-1-7-6-5-4-3, and the like, having at least about 362,880 different signatures. Likewise, considering the number of distinct permutations of possible combinations when there are 12 possible weight amounts (1, 2, 3, . . . , 12 grams), the number of distinct permutations of possible combinations is about equal to the product of the number of ways of choosing 8 different weight amounts (one for each component) from among the 12 possible weight amounts (1, 2, 3, . . . , 12 grams), which is 12 choose 8,

$$( \begin{matrix}12 \\ 8\end{matrix} ) = \frac{12 !}{8 ! ( 12 - 8 ) !} = \frac{12 !}{8 ! 4 !} = \frac{12 ⨯ 11 ⨯ 10 ⨯ 9}{4 ⨯ 3 ⨯ 2 ⨯ 1} = 495 ,$$

with the total number of permutations of the 8 different components, which is 8 factorial, 8!=8×7×6×5×4×3×2×1=40,320, so that the number of distinct permutations of possible combinations is about equal to 12 choose 8 times 8 factorial, which is

$$( \begin{matrix}12 \\ 8\end{matrix} ) 8 != \frac{12 !}{8 ! ( 12 - 8 ) !} 8 != \frac{12 !}{8 ! 4 !} 8 != \\ 495 ⨯ 8 != 495 ⨯ 40 \text{,} 320 = 19 \text{,} 958 \text{,} 400 ,$$

which is already more than about 19 million different compositions, among which are 12-9-8-7-6-5-4-3, 12-9-8-7-6-5-4-2, 12-9-8-7-6-5-4-1, 9-12-8-7-6-5-4-3, 9-8-12-7-6-5-4-3, 12-11-8-7-6-5-4-3, 12-11-8-7-6-5-4-2, 12-11-8-7-6-5-4-1, 11-12-8-7-6-5-4-3, 11-8-12-7-6-5-4-3, and the like, having at least about 19,958,400 different signatures.

Furthermore, considering the number of distinct permutations of possible combinations when there are 20 possible weight amounts (1, 2, 3, . . . , 20 grams), the number of distinct permutations of possible combinations is about equal to the product of the number of ways of choosing 8 different weight amounts (one for each component) from among the 20 possible weight amounts (1, 2, 3, . . . , 20 grams), which is 20 choose 8,

$$( \begin{matrix}20 \\ 8\end{matrix} ) = \frac{20 !}{8 ! ( 20 - 8 ) !} = \frac{20 !}{8 ! 12 !} = \frac{20 \times 19 \times 18 \times 17 \times 16 \times 15 \times 14 \times 13}{8 \times 7 \times 6 \times 5 \times 4 \times 3 \times 2 \times 1} = \text{125,970} ,$$

with the total number of permutations of the 8 different components, which is 8 factorial, 8!=8×7×6×5×4×3×2×1=40,320, so that the number of distinct permutations of possible combinations is about equal to 20 choose 8 times 8 factorial, which is

$$( \begin{matrix}20 \\ 8\end{matrix} ) 8 != \frac{20 !}{8 ! ( 20 - 8 ) !} 8 != \frac{20 !}{8 ! 12 !} 8 != \text{125,} \text{970} \times 8 != \text{125,970} \times \text{40,320} = \text{5,079,110,400,} \\$$

which is already more than about 5 billion different compositions, among which are 20-9-8-7-6-5-4-3, 20-9-8-7-6-5-4-2, 20-9-8-7-6-5-4-1, 9-20-8-7-6-5-4-3, 9-8-20-7-6-5-4-3, 20-11-8-7-6-5-4-3, 20-11-8-7-6-5-4-2, 20-11-8-7-6-5-4-1, 11-20-8-7-6-5-4-3, 11-8-20-7-6-5-4-3, 20-19-8-7-6-5-4-3, 20-19-8-7-6-5-4-2, 20-19-8-7-6-5-4-1, 19-20-8-7-6-5-4-3, 19-8-20-7-6-5-4-3, and the like, having at least about 5,079,110,400 different signatures. Thus, when a glass billet 120 is fabricated using eight different components, where the final billet of the glass 120 may contain 1, 2, 3, . . . , grams of each different component, in effect, a different composition may be selected from at least about 10,000 possibilities, or at least about 1.8 million possibilities, or possibly even more, depending on how the counting and/or the composing is done.

A given composition, producing a given signature, may be difficult to copy to produce an identical composition that produces substantially the same signature, for several reasons. One reason may be that the heat treatment and annealing (if any) may affect the signature, and those processing parameters may not be apparent from the composition. A second reason may be that the approach would typically be based on trial-and-error. However, as just described, for eight ingredients, the number of trials required may run into the millions. Furthermore, a trial-and-error approach may not actually amount to copying, since the original composition may not be copied, but numerous trials may be undertaken in pursuit of a composition having a property that is substantially similar to the property of the original composition. That may not be the same as copying an exact recipe, for example.

FIG. 16 schematically illustrates a scanner 1600, and a disc 1605, having a central hole 1607, which engages with an axle 1608. The disc 1605 may carry a collection of glass beads 1610. The disc 1605 may contain an indexing hole 1615, which engages with an indexing pin 1618, which allows the scanner 1600 to position a desired one of the glass beads 1610 at a scanning station, indicated in phantom at 1620. For example, assuming that a top side of the disc 1605 is defined, then the glass beads 1610 may be identified by their rank (first, second, third, and so forth) in the clockwise direction relative to the indexing hole 1615. The disc 1605, and/or other carrier, may carry a single glass bead 1610. The scanner 1600 may be controlled remotely, as by a computer 1650, which may select a specific glass bead 1610, and/or a specific sequence of glass beads 1610, for scanning. Thus, a sequence of signatures may be arbitrarily generated, to thwart hackers who may wish to synthesize the signatures.

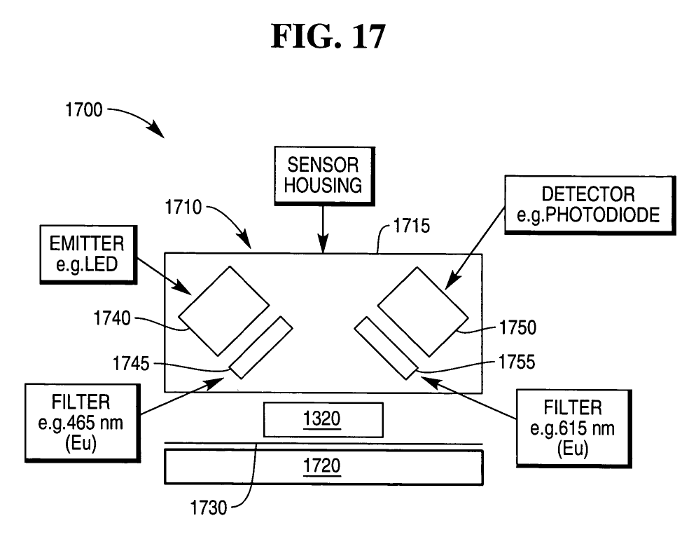

FIG. 17 schematically illustrates an arrangement 1700 for detecting information encoded in various illustrative embodiments in accordance with the present disclosure. This arrangement 1700 may include a sensor 1710 and a sample platform 1720 for supporting an item under test 1730. The sensor 1710 may have a housing 1715 in which may be provided an emitter 1740, for example, a light emitting diode (LED), at the output of which may be provided a first narrow band filter 1745. The first narrow band filter 1745 may allow only a very narrow, pre-determined range of wavelengths of electromagnetic radiation to be passed. As an example, the first narrow band filter 1745 may be selected to allow electromagnetic radiation having a narrow band pass centered on a wavelength of about 465 nm to pass through the first narrow band filter 1745 and toward the item under test 1730 on the sample platform 1720. Adjacent to the emitter 1740 may be a detector 1750, such as a photodiode. At the input to the detector 1750 may be a second narrow band filter 1755 that allows only a very narrow, pre-determined range of wavelengths of electromagnetic radiation to pass through the narrow band filter 1755. As an example, the second narrow band filter 1755 may be selected to allow electromagnetic radiation, such as light, centered on a wavelength of about 615 nm to reach the detector 1750.

In use of this arrangement 1700, electromagnetic radiation, such as light, may be emitted from the emitter 1740 and may be passed through the first narrow band filter 1745 and onto the item under test 1730 on the sample platform 1720. The item under test 1730 may be an item that carries and/or includes a marker 1320 comprising a plurality of glass beads, such as the fragments/powder 130, 1150, 1315, 1505, 1610, for example, disposed within an ink, each of the glass beads capable of emitting electromagnetic radiation having at least one known characteristic frequency in response to electromagnetic radiation having at least one predetermined excitation frequency, the plurality of the glass beads selected to encode information for marking at least one product, the ink having been used to mark the at least one product and/or at least one package for the at least one product. This electromagnetic radiation, such as light, may be absorbed by the rare earth dopant disposed within one or more of the plurality of glass beads, such as the fragments/powder 130, 1150, 1315, 1505, 1610, for example.

If the energy of the electromagnetic radiation, such as light, matches one or more of the energy levels of the rare earth dopant and the carrier used, the electromagnetic radiation, such as light, may be absorbed, exciting one or more electrons into one or more excited states. The structure of the energy levels of the rare earth dopant and the carrier used may then cause the one or more electrons to de-excite, leading to emission of electromagnetic radiation, such as luminescence, for example, causing the plurality of glass beads, such as the fragments/powder 130, 1150, 1315, 1505, 1610, for example, to luminescence. Electromagnetic radiation, such as light, for example, emitted from the item under test 1730, may be transmitted towards the second narrow band filter 1755, and from there, to the detector 1750. Also the emission from each marker 1320 may decay over a different time period. By virtue of this feature, the time over which an emission occurs for a particular wavelength of electromagnetic radiation may be used as part of a profile, such as a security profile, for example. For authentic documents, the electromagnetic radiation, such as light, for example, received at the detector 1750 should have one or more characteristic features that may be identified. In the event that the detected response has the expected features, the item under test 1730 may be identified as being bona fide. In the event that the response is not as expected and/or is not within an acceptable range of the expected response, the item under test 1730 may be identified as being a potential counterfeit.

The spectral emissions of various marker 1320 samples have been investigated. As an example, FIG. 18 shows a table 1800 of the emission wavelengths and intensities for various different excitation wavelengths for a marker 1320 sample comprising 3 mol % Eu Cl₃ when included in the borosilicate glass described above.

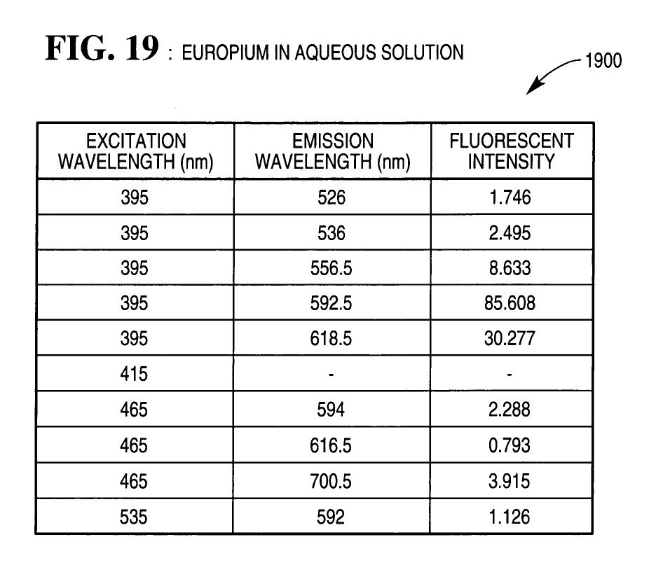

By way of comparison, FIG. 19 shows the corresponding results in a table 1900 for the EuCl₃:6H₂O dopant, but when in solution. From FIGS. 18 and 19, it may be seen that in the borosilicate glass the most significant excitation is at about 395 nm, which emits at 615 nm, 590.5 nm, 535 nm, and 654 nm (listed by intensity from largest to smallest). The corresponding results for the EuCl₃:6H₂O in solution shows that the emission wavelengths here are 592.5 nm, 618.5 nm, 556.5 nm, 536 nm, and 526 nm (listed by intensity from largest to smallest). Hence, the spectral response of the marker 1320 sample at 395 nm is significantly different from that of the EuCl₃:6H₂O in solution. Also, in the borosilicate glass, for excitation at a wavelength of 415 nm, there is an output of 615 nm and 590.5 nm. In contrast, for the EuCl₃:6H₂O in solution, there is effectively no luminescence at this wavelength. Again, this demonstrates that there is significant and measurable difference caused by the incorporation of the EuCl₃:6H₂O in the borosilicate carrier.

Because rare earth atoms have well defined and relatively narrow, non-overlapping spectral bands, this means for many applications it is possible to detect the marker 1320, such as the security marker 1320, for example, using a single discrete pre-determined excitation wavelength and likewise a single discrete pre-determined detection wavelength. For example, for the EuCl₃ doped borosilicate glass described above, the narrow-band emitter filter 1745 may be selected to be 465 nm, and the narrow-band detector filter 1755 may be selected to be 615 nm. Alternatively, a plurality of stimulating wavelengths may be used. To do this, a number of different suitable narrow-band emitter filters 1745 may be selected, and a plurality of corresponding narrow-band detector filter 1755 may be selected. These may be included in the arrangement 1700 of FIG. 17 to allow the simultaneous measurement of electromagnetic response, such as optical response, at various different wavelengths.

A further advantage of the discrete nature of spectral response of rare earth atoms is that a number of species may be combined into the one product for improved security for example 3 mole % Eu+3 mole % Tb, not precluding other types of rare earth atoms at different mole percentages and/or weight percentages and/or more than two types of rare earth atoms. Because the response of the various different dopants is relatively discrete, detection of these is simplified. The narrow emission bands also facilitate the spectral selection of the rare earth atoms and/or molecules comprising rare earth atoms, making the detection system simpler than those required for systems containing multiple dyes. A further advantage is that many rare earth atoms require excitation at wavelengths conducive to existing laser diode technologies. This makes in situ excitation possible because the excitation source is compact, robust, and long lived. Furthermore, incorporating the rare earth dopants into a suitable carrier, and, in particular, the glass beads, such as the fragments/powder 130, 1150, 1315, 1505, 1610, for example, described herein, means that the marker 1320, such as the security marker 1320 in which various illustrative embodiments may be embodied may be extremely stable under adverse chemical, environmental, and/or physical abrasion conditions, thereby ensuring that it has a long lifetime compared to conventional dyes.

Those of ordinary skill in the art having the benefit of the present disclosure may appreciate that variations of the arrangements disclosed herein are possible without departing from the scope of the claims below. For example, whilst only a few rare earth atoms have been specifically described, it may be appreciated that there is a wide range of luminescent rare earth atoms that may be used. The number of permutations available is therefore greatly enhanced. In addition, whilst some rare earth atoms emit in the ultra-violet (UV) and/or infra-red (IR) ranges, it may be more beneficial for some applications that both the excitation radiation and the emitted radiation be within the visible range, that is, within a wavelength range that is visible to the unaided human eye. Accordingly, the above description of various specific illustrative embodiments is made by way of example only and not for the purposes of limitation. It will be clear to those of ordinary skill in the art having the benefit of the present disclosure that minor modifications may be made without significant changes to the operation described. In various other illustrative embodiments, other luminescent carriers may be used that do not rely on rare earth doping, for example, carriers including phosphorescent material, dyes, and the like.

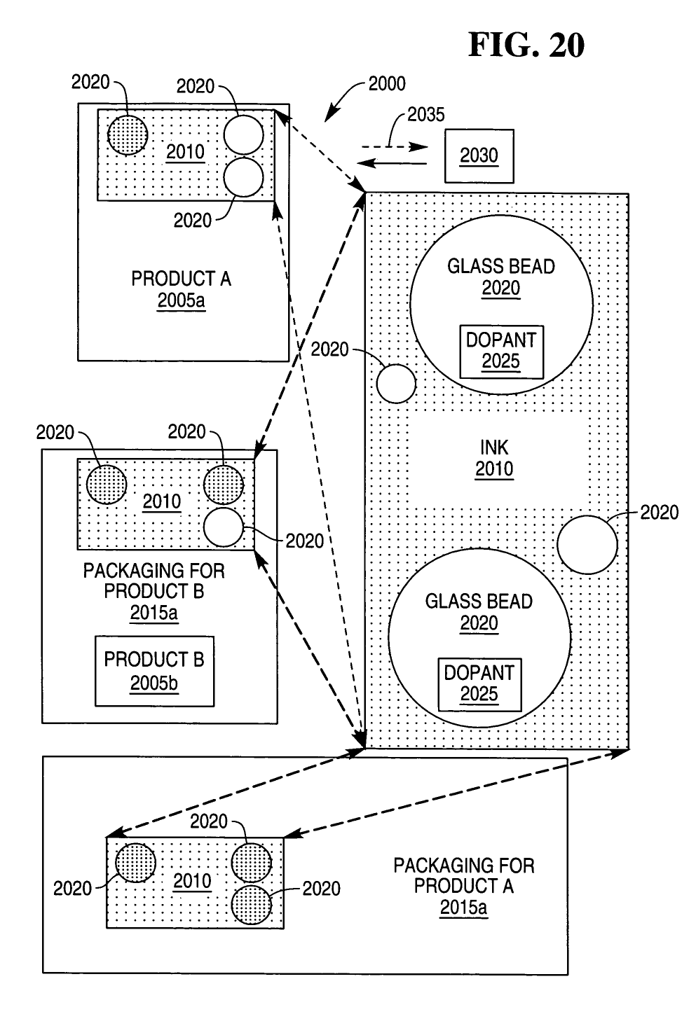

FIG. 20 schematically illustrates various exemplary embodiments of a system 2000 for indicating marking information for at least one product 2005a, to at least one person, for example a visually impaired person, according to teachings of the present disclosure. In various illustrative embodiments, as shown in FIG. 20, the system 2000 for indicating marking information for at least one product 2005a, 2005b to at least one person may be provided. The system 2000 may comprise an ink 2010 (as shown magnified at the right of FIG. 20, as indicated by the dotted arrows) having a plurality of glass beads 2020 (not drawn to scale) disposed within, each of the glass beads 2020 capable of emitting electromagnetic radiation having at least one known characteristic frequency in response to electromagnetic radiation having at least one predetermined excitation frequency, the plurality of the glass beads 2020 selected to encode information for marking the at least one product 2005a, 2005b using the ink 2010 to mark the at least one product 2005a, 2005b and/or at least one package 2015a, 2015b for the at least one product 2005a, 2005b. For example, the ink 2010 may be used to print on the at least one product 2005a, 2005b and/or at least one package 2015a, 2015b for the at least one product 2005a, 2005b. The system 2000 may also comprise a reader 2030 capable of decoding the information for marking the at least one product 2005a, 2005b, as indicated schematically at 2035. For example, the different encodings for the at least one product 2005a, 2005b and/or at least one package 2015a, 2015b for the at least one product 2005a, 2005b may be schematically indicated by the different number of shaded glass beads 2020 shown in the respective inks 2010. In the example shown, Product A has one shaded glass bead 2020, the packaging for Product B has two shaded glass beads, and the packaging for Product C has three shaded glass beads. Each of the shaded glass beads indicates coding. For example, a single shaded glass bead on the figure may mean that the encoding is obtained through glass beads uniformly doped to provide the same response to electromagnetic radiation. Two shaded glass beads on the figure may mean that the encoding is obtained through two types of glass beads, each type doped to provide different responses to electromagnetic radiation, and so on. These are just examples. A large number of coding possibilities are possible with this technique. The different encodings may each be decodable by the reader 2030.

In various illustrative embodiments, the system 2000 for indicating marking information for at least one product 2005a, 2005b to at least one person, for example a visually impaired person, may also comprise the reader 2030 capable of decoding the information for marking the at least one product 2005a, 2005b, as indicated at 2035, wherein at least some of the plurality of the glass beads 2020 may have at least one dopant 2025 disposed within. The at least one dopant 2025 disposed within at least some of the plurality of the glass beads 2020 may render at least some of the plurality of the glass beads 2020 capable of responding to at least one luminescence-exciting frequency and/or at least one narrow-band radio-frequency (RF) excitation.

In various illustrative embodiments, the system 2000 for indicating marking information for at least one product 2005a, 2005b to at least one person, for example a visually impaired person, may further comprise the reader 2030 capable of decoding the information for marking the at least one product 2005a, 2005b, as indicated at 2035, wherein the reader 2030 is capable of exposing the ink 2010 to the at least one predetermined excitation frequency of radiation. In various illustrative embodiments, the system 2000 for indicating marking information for at least one product 2005a, 2005b to at least one person, for example a visually impaired person, may further comprise the reader 2030 capable of decoding the information for marking the at least one product 2005a, 2005b, as indicated at 2035, wherein the reader 2030 is capable of exposing the ink 2010 to the at least one predetermined excitation frequency of radiation and detecting the at least one known characteristic frequency.

In various illustrative embodiments, the system 2000 for indicating marking information for at least one product 2005a, 2005b to at least one person, for example a visually impaired person, may further comprise the reader 2030 capable of decoding the information for marking the at least one product 2005a, 2005b, as indicated at 2035, wherein the reader 2030 is capable of exposing the ink 2010 to the at least one predetermined excitation frequency of radiation and detecting the at least one known characteristic frequency by absorbing the at least one known characteristic frequency and, depending on the at least one known characteristic frequency, thereafter decoding the information for marking the at least one product 2005a, 2005b, as indicated at 2035. In various illustrative embodiments, the system 2000 for indicating marking information for at least one product 2005a, 2005b to at least one person, for example a visually impaired person, may further comprise the reader 2030 capable of decoding the information for marking the at least one product 2005a, 2005b, as indicated at 2035, wherein the reader 2030 is capable of exposing the ink 2010 to the at least one predetermined excitation frequency of radiation, detecting the at least one known characteristic frequency by absorbing the at least one known characteristic frequency and, depending on the at least one known characteristic frequency, thereafter decoding the information for marking the at least one product 2005a, 2005b, as indicated at 2035, and then indicating the information for marking the at least one product 2005a, 2005b, as indicated at 2035, to at least one person, for example a visually impaired person, using an audible tone, a series of audible tones, and/or a tactile response indicator such as Braille, and the like.

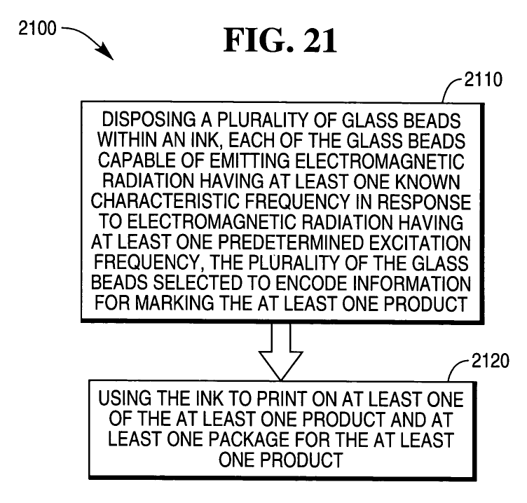

FIG. 21 schematically illustrates various exemplary embodiments of a method 2100 for marking at least one product 2005a, according to teachings of the present disclosure. In various illustrative embodiments, as shown in FIG. 21, the method 2100 for marking at least one product 2005a, 2005b may be provided. The method 2100 may comprise disposing the plurality of glass beads 2020 within the ink 2010, each of the glass beads 2020 capable of emitting electromagnetic radiation having at least one known characteristic frequency in response to electromagnetic radiation having at least one predetermined excitation frequency, the plurality of the glass beads 2020 selected to encode information for marking the at least one product 2005a, 2005b, as indicated at 2110. The method 2100 may comprise using the ink 2010 to mark at least one product 2005a, 2005b and/or at least one package 2015a, 2015b for the at least one product 2005a, 2005b, as indicated at 2120.

In various illustrative embodiments, the method 2100 may further comprise disposing the plurality of the glass beads 2020 within the ink 2010, each of the glass beads 2020 capable of emitting the electromagnetic radiation having the at least one known characteristic frequency in response to the electromagnetic radiation having the at least one predetermined excitation frequency comprising at least one of at least one luminescence-exciting frequency and at least one narrow-band radio-frequency (RF) excitation. In these various illustrative embodiments, the method 2100 may further comprise at least some of the plurality of the glass beads 2020 having at least one dopant 2025 disposed within rendering the at least some of the plurality of the glass beads 2020 capable of responding to the at least one of the at least one luminescence-exciting frequency and the at least one narrow-band radio-frequency (RF) excitation. In various illustrative embodiments, the glass beads 2020 may not be glass at all. Instead, the matrix for the dopant may be a polymer. In some cases, for example when Buckminsterfullerenes are used, the “glass beads” 2020 may not have a matrix.

In various illustrative embodiments, a method for marking products by using a glass bead within an ink that resonates in response to a predetermined excitation may be provided. The resonance may then be uniquely encoded to describe the contents of the package containing the product so marked. Such methods may have one or more glass beads disposed within the ink used to print the packaging, for example. The glass beads may be designed to resonate at one or more known frequencies in response to one or more predetermined excitations.

In various illustrative embodiments, the method 2100 may further comprise exposing the ink 2010 to the electromagnetic radiation having the at least one predetermined excitation frequency. In various illustrative embodiments, the method 2100 may further comprise exposing the ink 2010 to the electromagnetic radiation having the at least one predetermined excitation frequency and detecting the at least one known characteristic frequency, for example, using the detector 2030. In various illustrative embodiments, the method 2100 may further comprise exposing the ink 2010 to the electromagnetic radiation having the at least one predetermined excitation frequency, detecting the at least one known characteristic frequency, for example, using the detector 2030, and decoding the information for marking the at least one product 2005a, 2005b. In various illustrative embodiments, the method 2100 may further comprise exposing the ink 2010 to the electromagnetic radiation having the at least one predetermined excitation frequency, detecting the at least one known characteristic frequency, for example, using the detector 2030, decoding the information for marking the at least one product 2005a, 2005b, and indicating the information for marking the at least one product 2005a, 2005b to at least one person, for example a visually impaired person, using an audible tone, a series of audible tones, and/or a tactile response indicator, such as Braille, and the like.

In various illustrative embodiments, a reader may be employed that may have a narrow-band radio-frequency (RF) excitation. Disposed within the glass bead may be a dopant that responds to the narrow-band radio-frequency (RF) excitation. The reader may absorb the emissions emitted in response to the narrow-band radio-frequency (RF) excitations and, depending upon the one or more frequencies of the response, indicate the code. For example, if a currency note may include an ink having one or more glass beads, the reader may bathe the currency note in the narrow-band radio-frequency (RF) excitation. The reader may be presented at close range to ensure a large signal-to-noise ratio. One or more of the glass beads may resonate in response to the narrow-band radio-frequency (RF) excitation. The reader may then absorb that response and may determine the respective corresponding code, having decoded the denomination of the currency note, for example. The reader may then indicate the code, such as the denomination of the currency note, as a tone, a series of tones, and/or even a tactile response, such as Braille, and the like. In alternative illustrative embodiments, a data-to-speech system, as described above, may be used to indicate the code, such as the denomination of the currency note.

The method and system disclosed herein, for marking at least one product and/or for indicating marking information for at least one product to at least one person, for example a visually impaired person, provides a method and/or a system allowing at least one person to “read” marking information for at least one product and/or at least one package for the at least one product. Furthermore, the method and system disclosed herein, for marking at least one product and/or for indicating marking information for at least one product to at least one person, for example a visually impaired person, is advantageous in providing a method and/or a system that increases security.

The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, in the sense of Georg Cantor. Accordingly, the protection sought herein is as set forth in the claims below.

Although various illustrative embodiments of the present invention and their advantages are described in detail, a person skilled in the art having the benefit of the present disclosure could make various alterations, additions, and/or omissions without departing from the spirit and scope of the present invention, as defined by the appended claims.

What is claimed is:

1. A reader capable of identifying at least one product by providing non-visual sensory information to a user, the reader comprising: a source which stimulates a response from a marker carried by the at least one product; a detector which detects the response from the marker; a decoder which decodes the detected response to ascertain product identification information therefrom; and a transducer which provides the product identification information in non-visual form.

2. The reader of claim 1, wherein the source is an excitation source, and the marker comprises at least one luminophore.

3. The reader of claim 1, wherein the detector measures luminescence intensity at one or more wavelengths.

4. The reader of claim 1, wherein the transducer produces at least one audible tone.

5. The reader of claim 1, wherein the transducer produces an audible description to identify the product.

6. The reader of claim 1, wherein the transducer produces a tactile response that can be interpreted by a user.

7. The reader of claim 1, wherein the source is a radio-frequency source, and the marker is a radio-frequency identification device.

8. The reader of claim 7, wherein the detector is a radio-frequency detector.

9. A method for marking at least one product, the method comprising:
selecting a plurality of luminophores to encode information relating to the at least one product;
disposing the selected plurality of luminophores within an ink;
applying the ink to the at least one product to facilitate subsequent automated reading and decoding of the luminophores to present the information and thereby identify the at least one product.

10. The method of claim 9, further comprising:
exposing the ink to the electromagnetic radiation having the at least one predetermined excitation frequency.

11. The method of claim 10, further comprising:
detecting the at least one known characteristic frequency; and
decoding the information for marking the at least one product.

12. The method of claim 11, further comprising:
indicating the information for marking the at least one product to at least one person using at least one of an audible tone, a series of audible tones, and a tactile response indicator.

13. A system for indicating marking information for at least one product, the system comprising:
an ink having a plurality of luminophores disposed within, each of the luminophores capable of emitting electromagnetic radiation having at least one known characteristic frequency in response to electromagnetic radiation having at least one predetermined excitation frequency, the plurality of the luminophores selected to encode information for marking the at least one product using the ink to mark at least one of the at least one product and at least one package for the at least one product; and
a reader capable of decoding the information for marking the at least one product.

14. The system of claim 13, wherein the reader is capable of exposing the ink to the at least one predetermined excitation frequency of radiation and detecting the at least one known characteristic frequency by absorbing the at least one known characteristic frequency and, depending on the at least one known characteristic frequency, thereafter decoding the information for marking the at least one product, and then indicating the information for marking the at least one product to at least one person using at least one of an audible tone, a series of audible tones, and a tactile response indicator.

15. A system for indicating marking information for at least one product, the system comprising:
an ink having a plurality of luminophores disposed within, each of the luminophores capable of emitting electromagnetic radiation having at least one known characteristic frequency in response to electromagnetic radiation having at least one predetermined excitation frequency, the plurality of the luminophores selected to encode information for marking the at least one product using the ink to mark at least one of the at least one product and at least one package for the at least one product; and
a reader capable of decoding the information for marking the at least one product, wherein at least some of the plurality of the luminophores have at least one dopant disposed within rendering the at least some of the plurality of the luminophores capable of responding to at least one of at least one luminescence-exciting frequency and at least one narrow-band radio-frequency (RF) excitation.

16. The system of claim 15, wherein the reader is capable of exposing the ink to the at least one predetermined excitation frequency of radiation, detecting the at least one known characteristic frequency by absorbing the at least one known characteristic frequency and, depending on the at least one known characteristic frequency, thereafter decoding the information for marking the at least one product, and then indicating the information for marking the at least one product to at least one person using at least one of an audible tone, a series of audible tones, and a tactile response indicator.
